(19) United States
(12) Patent Application Publication
(10) Pub. No.: US 2026/0359314 A1
(43) Pub. Date: Nov. 12, 2026

(54) RETRIEVAL AND RANKING WITH AUTOMATIC ALIGNMENT

(71) Applicant: Microsoft Technology Licensing, LLC, Redmond, WA (US)

(72) Inventors: Qianqi Shen, Saratoga, CA (US); Srividya Krishnamurthy, Santa Clara, CA (US); Shaobo Zhang, Bellevue, WA (US); Yuchin Juan, Bellevue, WA (US); Luke E. Simon, Emerald Hills, CA (US); Steven X. Xu, Sunnyvale, CA (US); Declan P. Boyd, San Mateo, CA (US); Chengming Jiang, Sunnyvale, CA (US); Jianqiang Shen, Saratoga, CA (US); Jeffrey W. Lee, Sunnyvale, CA (US)

(21) Appl. No.: 19/204,389

(22) Filed: May 9, 2025

(51) Int. Cl. G06F 16/248; G06N 20/00

(52) U.S. Cl. CPC G06F 16/248; G06N 20/00

(57) ABSTRACT

An example provides entity-item pairs to a first machine learning model, receives a first subset of the entity-item pairs from the first machine learning model, provides the first subset to a second machine learning model, and receives first predictive output from the second machine learning model. The first predictive output is generated by the second machine learning model based on the first subset. An example provides the entity-item pairs to the second machine learning model and receives second predictive output from the second machine learning model. The second predictive output is generated by the second machine learning model based on the entity-item pairs. An alignment of a first objective of the first machine learning model with a second objective of the second machine learning model is computed using the first predictive output and the second predictive output. The alignment may be used to update the first machine learning model.

### TECHNICAL FIELD

Technical fields to which this disclosure relates include retrieval and ranking systems. Other technical fields to which this disclosure relates include alignment techniques for multi-stage retrieval and ranking systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

A retrieval and ranking system is a computer system that is designed to find and order items based on a criterion, such as relevance to a given query. Retrieval and ranking systems are used in search engines, recommendation systems, and other applications where information needs to be efficiently retrieved and ranked.

Natural Language Processing (NLP) is a subfield of computer science and artificial intelligence that focuses on enabling computers to understand, interpret, and generate natural human language in an electronic form. NLP often combines computational linguistics, machine learning, and deep learning techniques to process and analyze large amounts of natural language data.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for retrieval and ranking using multiple serving paths and an alignment and learning service in accordance with some examples of the present disclosure.

FIG. 2 is a component-based flow diagram of an example method for retrieval and ranking using multiple serving paths and an on-processor environment in accordance with some examples of the present disclosure.

FIG. 3 is a component-based flow diagram of an example method for training a machine learning model for retrieval and ranking in accordance with some examples of the present disclosure.

FIG. 4 is a component-based flow diagram of an example method for retrieval and ranking using an auction service in accordance with some examples of the present disclosure.

FIG. 5 is a flow diagram of an example method for retrieval and ranking in accordance with some examples of the present disclosure.

FIG. 6 is a block diagram of a computing system that includes retrieval and ranking in accordance with some examples of the present disclosure.

FIG. 7A, FIG. 7B, and FIG. 7C are block diagrams of examples of machine learning models that are usable by and/or included in a retrieval and ranking system in accordance with some examples of the present disclosure.

FIG. 8 is a block diagram of an example computer system including components of a retrieval and ranking system in accordance with some examples of the present disclosure.

### DETAILED DESCRIPTION

Many application software systems perform retrieval and ranking of items, such as digital content items, with respect to individual entities, such as users. Retrieval and ranking systems have been used to match items to user preferences, generate recommendations, populate news feeds, and/or filter content before presentation to a user. An ongoing technical problem for application software systems is how to perform retrieval and ranking with low latency and scalability for a large number of entities (e.g., millions of users) and a potentially much larger number of items (e.g., tens or hundreds of millions of digital content items).

Some machine learning models, such as language models, are capable of performing natural language processing (NLP) tasks that are useful for retrieval and ranking. Attempts have been made to use these models to improve retrieval and ranking systems. However, high latency due to the model complexity and the size of the requisite inputs has been a barrier to implementation, particularly in environments where low latency and/or high scalability are needed or desired.

Attempts have been made to resolve latency issues by dividing the retrieval and ranking process into multiple stages. In a retrieval stage, a machine learning model identifies items based on a criterion. In a ranking stage, a machine learning model ranks items identified by the retrieval stage so that, ideally, the highest-ranking item(s) are selected for further processing and/or presentation to a user.

However, dividing the retrieval and ranking process into multiple stages can introduce alignment issues between the stages. Alignment issues may arise when the retrieval and ranking stages are performed using machine learning models that are optimized for different objectives. For instance, if a retrieval model is optimized for conversion (e.g., probability of a user taking an action on an item) while a ranking model is optimized for engagement (e.g., probability of a user selecting an item), the outputs of the retrieval model and the ranking model may be misaligned in that the retrieval output might include items that would not have been included in the output of the ranking model, or the retrieval output might not include items that would have been included in the output of the ranking model.

Misalignment of retrieval and ranking models decreases the overall performance of the retrieval and ranking system. Performance suffers if an item that would have been ranked highly by the ranking stage is not identified by the retrieval stage, because that item will not be included in the input to the ranking stage and thus will be omitted from the output produced by the ranking stage. Performance also suffers if an item identified by the retrieval stage, and therefore included in the input to the ranking stage, is subsequently ranked low by the ranking stage. In this case, the low-ranked item is likely to be excluded from the output produced by the ranking stage, leaving a sub-optimal result set if a higher-ranking item could have been included had it been identified by the retrieval stage.

Attempts to address misalignment in multi-stage retrieval and ranking systems have involved the use of rule-based logic, which is resource intensive, in terms of computing resources and developer time, to implement and maintain. Additionally, these other alignment approaches have not been automatically integrated with the online serving path of the retrieval and ranking system. Approaches that do not provide automatic integration are sub-optimal because misalignments affecting retrieval and ranking results can occur between the scheduled alignments.

Examples of the described techniques address these and/or other technical challenges by reducing the number of components in a first retrieval and ranking serving path and/or by incorporating an automatic, real-time alignment component via a second serving path. Examples provide fewer stages of retrieval and ranking along with improved alignment over other approaches.

In some examples, a first serving path includes a retrieval service and a first ranking service, where the output of the retrieval service is input to the first ranking service, while a second serving path includes a second ranking service that operates on the same input as the retrieval service of the first serving path. An alignment component evaluates the output of the first ranking service in comparison to the output of the second ranking service. The output of the alignment component is used to backpropagate adjustments of model parameter values or coefficients from the first ranking service to the first retrieval service in the first serving path.

In some examples, the retrieval service includes a machine learning model that is trained using pseudo labels that are generated by the first ranking service. In other words, the model used in the retrieval service is an approximation of the model used in the first ranking service. In some examples, the retrieval model is a “student” model that is created via a distillation process using the first ranking model as a “teacher” model. In some examples, a learning component receives feedback in response to presentation of items via the first serving path and provides label updates back to the first ranking service, e.g., via a reinforcement learning process. These label updates are then provided back to the retrieval service as pseudo label updates using the distillation process.

In some examples, a portion of the retrieval service is implemented on-processor to improve latency in the first serving path by applying a processor directly to operations that are capable of being performed efficiently on the processor. In some examples, a filtering service is included in the first serving path and/or the second serving path to improve latency by reducing the size of the input to the retrieval service and/or the ranking service, as the case may be.

In some examples, a retrieval and ranking system includes an auction service. In an auction, the retrieval and ranking of items is further influenced by weight values, e.g., bids or “boost” values, which are provided by or associated with content providers. In the auction context, a weight value (e.g., bid amount submitted by a content provider) is often unrelated to or independent of typical retrieval and ranking objectives like relevance, engagement, and conversion and instead is dependent upon the total amount of possible weight value available to an individual content provider (e.g., the content provider's available budget at the time of the auction).

The objective of an auction model is to select item(s) for a downstream task, such as presentation of item(s) via slot(s) in a user interface, such that the selected item(s) have the highest associated weight values (or boost values) when compared to the weight values of other items that could have been selected but are not selected. The additional objective of optimizing weight values in an auction may further cause misalignment between stages of a retrieval and ranking system. However, the approaches described herein are applicable to and have been shown to improve the performance of auction-based retrieval and ranking systems alternatively or in addition to other types of retrieval and ranking systems.

For example, whereas other approaches have preceded or gated the auction with several stages of retrieval, ranking, and filtering (resulting in a “small” auction at the end of the pipeline), the techniques described herein are capable of automatically aligning the retrieval and ranking stages with the objectives of the auction so that, essentially, the end to end retrieval and ranking pipeline functions like a “big” unified auction across the stages.

Whether an auction is considered a “big” auction or a “small” auction is based on the number of items being evaluated by the auction service. In small auction approaches, the retrieval, filtering, and ranking stages that precede the auction reduce the number of items that are input to the auction so that a number of items are excluded from the auction stage, in order to make the auction stage more efficient. In the big auction approaches described herein, retrieval and ranking models are aligned with the auction objectives so that those objectives are applied to all of the retrieval and ranking stages, e.g., earlier in the pipeline, when a larger number of items are being evaluated. The described approaches are thereby capable of reducing the risk of misalignment and improving the performance of the retrieval and ranking system.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

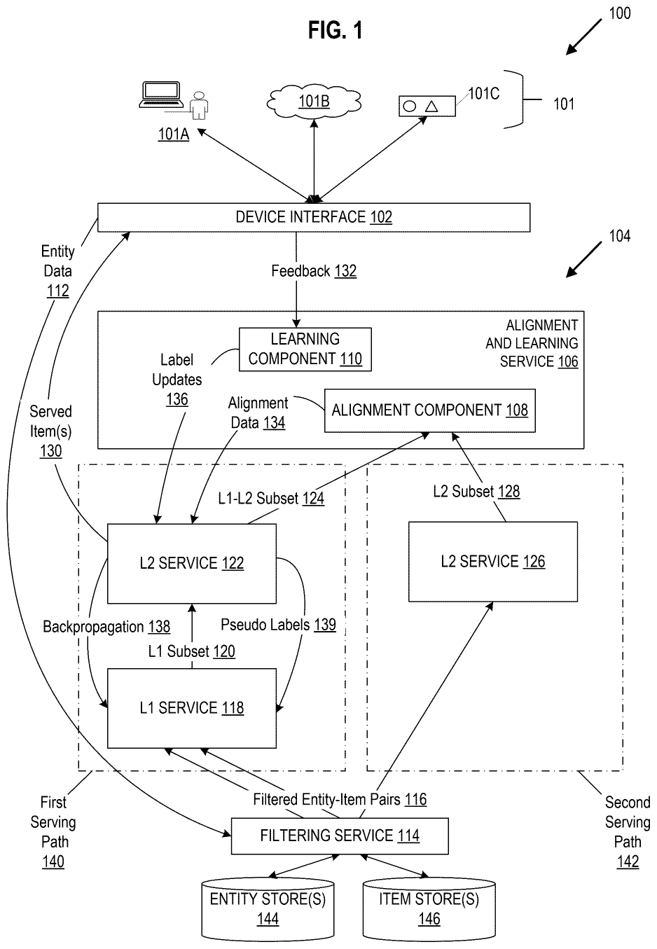

FIG. 1 is a component-based flow diagram of an example method for retrieval and ranking in accordance with some examples of the present disclosure.

For instance, FIG. 1 illustrates a method 100. The method 100 includes operations performed by a computing system that includes a retrieval and ranking system 104. Portions of the method 100 include communications between components of the retrieval and ranking system 104 and/or other components of the computing system.

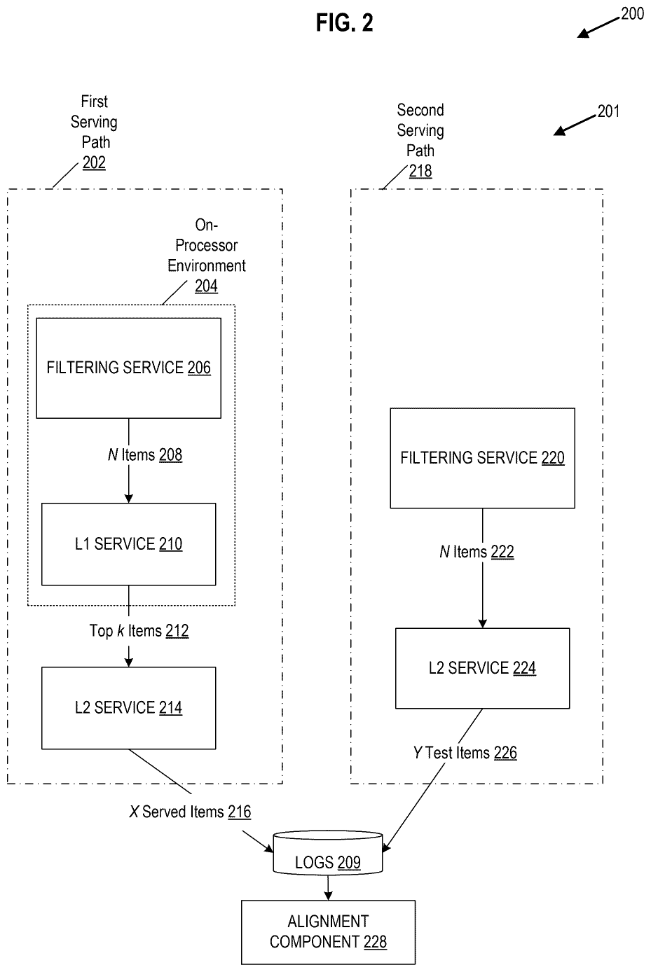

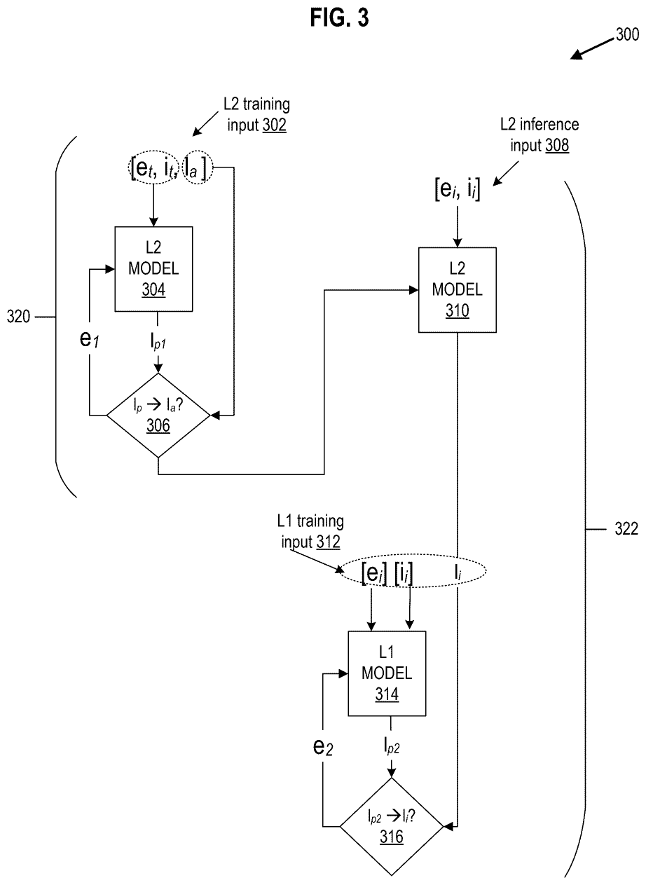

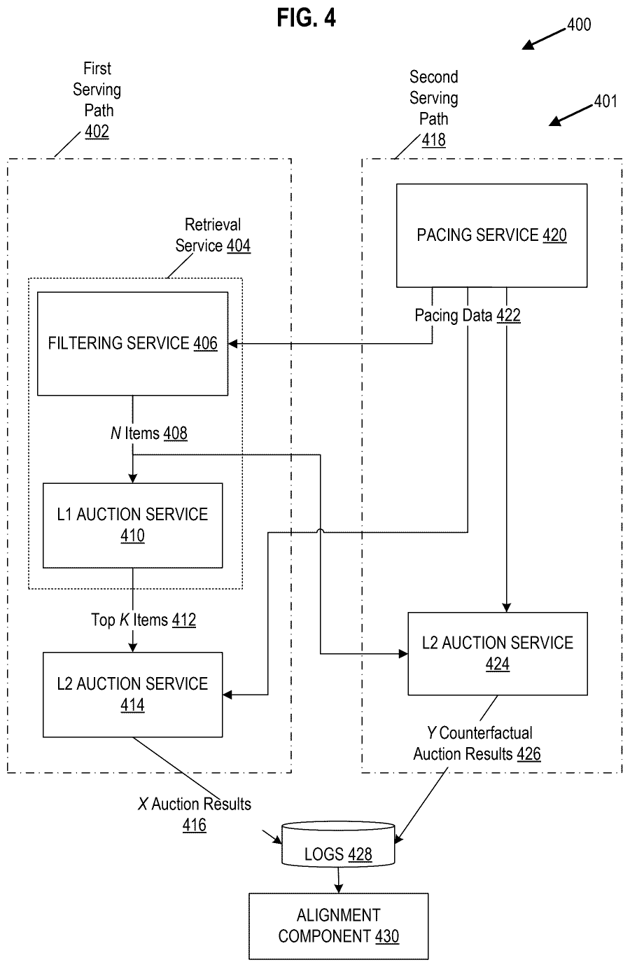

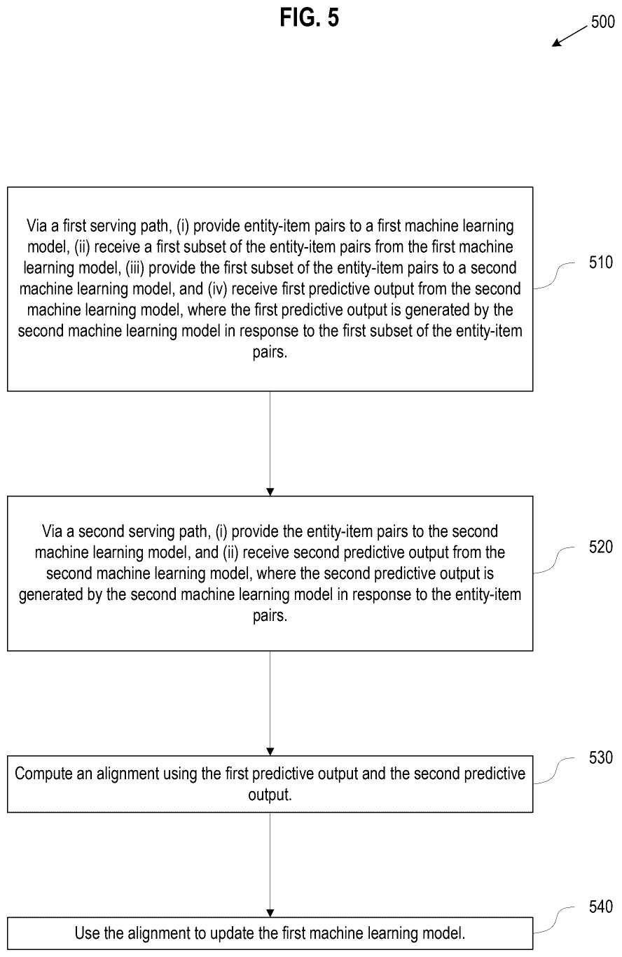

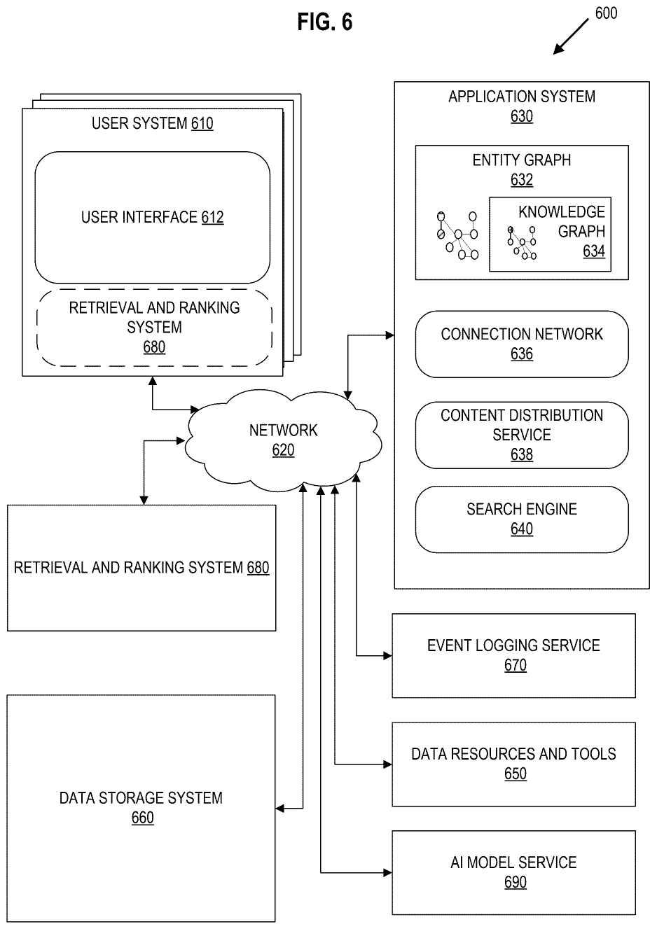

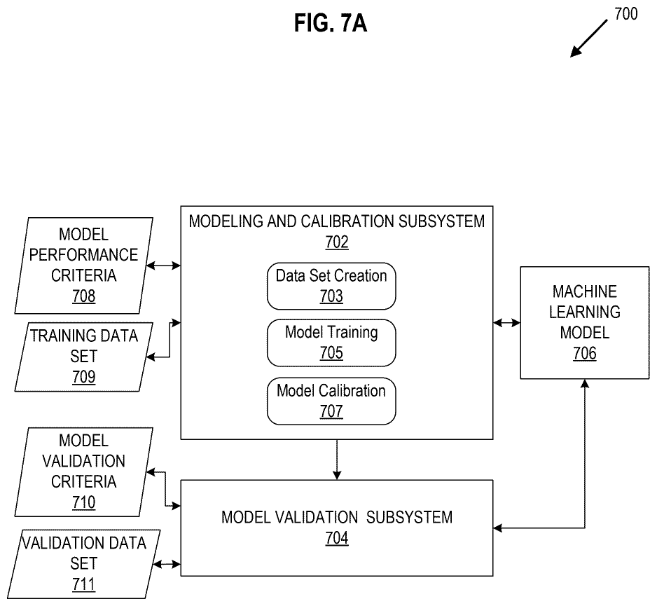

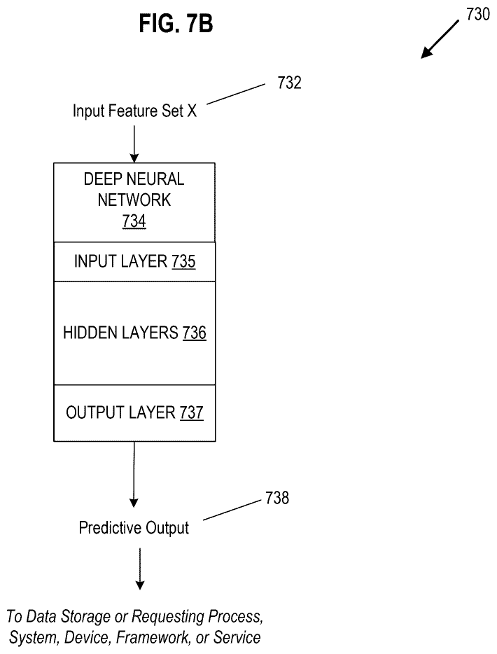

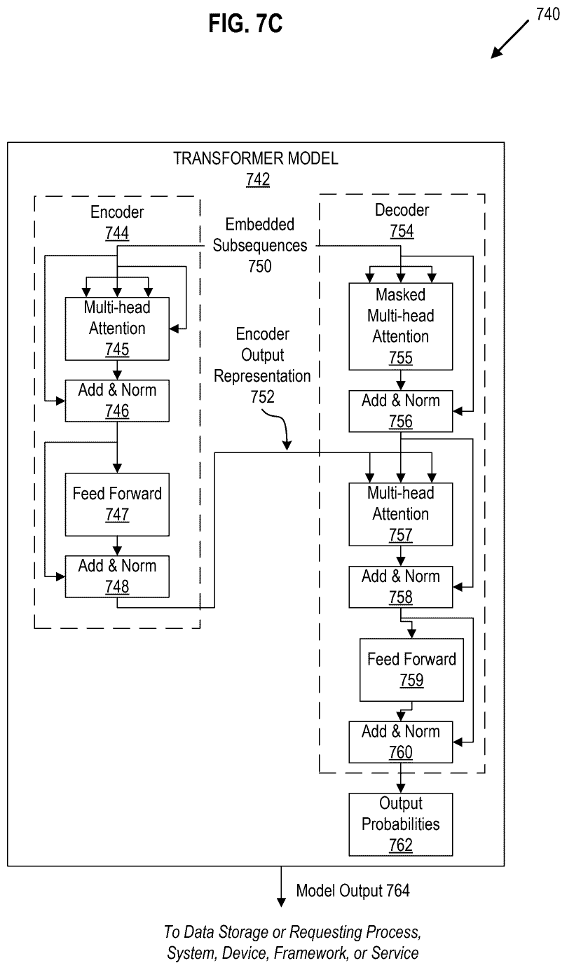

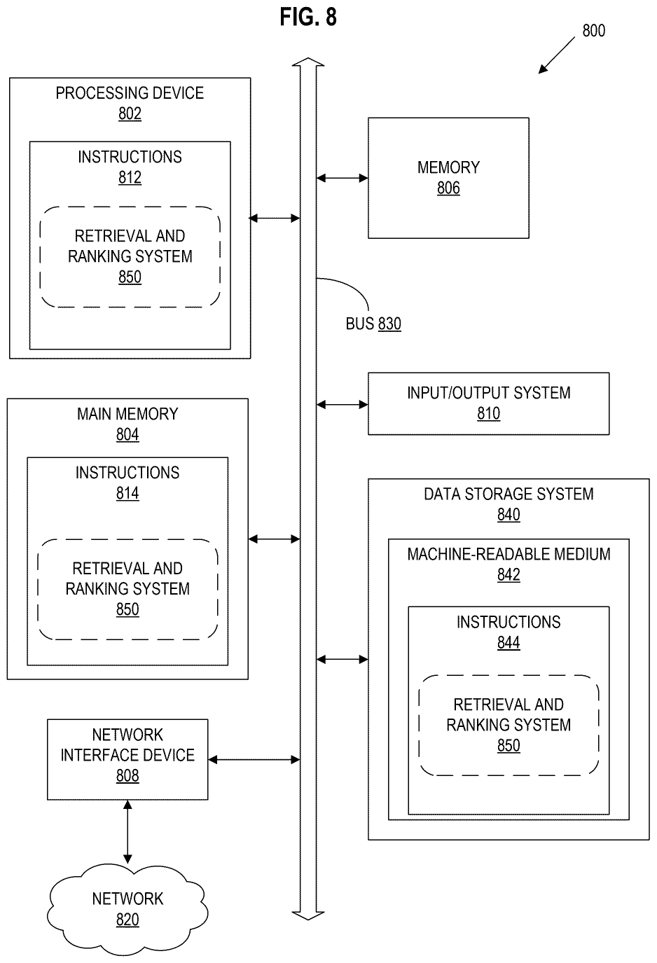

The method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 100 is performed by one or more computing system components shown in FIG. 1. In other examples, portions of the method 100 are performed by one or more computing system components shown in FIG. 2, FIG. 3, FIG. 4, FIG. 5, one or more components of computing system 600 of FIG. 6, one or more machine learning models of FIG. 7A, FIG. 7B, and/or FIG. 7C, and/or retrieval and ranking system 850 of FIG. 8. Although shown in a particular sequence or order, unless otherwise specified, the order of the processes is modifiable. In some examples, the processes are performed in a different order and/or some processes are performed in parallel. Additionally, one or more processes are omitted in some examples. Thus, not all processes are required in every example. Other process flows are possible.

In FIG. 1, the method 100 is represented by arrows connecting components of the illustrated computing system. The computing system of FIG. 1 includes an environment 101, a device interface 102, and the retrieval and ranking system 104. Examples of computing systems including a retrieval and ranking system such as the retrieval and ranking system 104 shown in FIG. 1 are described with reference to, e.g., FIG. 6 and FIG. 8.

The environment 101 includes one or more user devices 101A, one or more networks 101B, and/or one or more sensing devices 101C. A non-exhaustive list of examples of user devices 101A includes computing devices, such as laptop computers, smart phones, mobile computing devices, smart appliances, wearable devices, accessibility devices, game controls, vehicle controls, buttons, switches, haptic devices, and robotic devices. A non-exhaustive list of examples of networks 101B includes wireless, optical, and/or wired communication networks. A non-exhaustive list of examples of sensing devices 101C includes motion sensors, load cells, force sensors, pressure sensors, angle sensors, light sensors, temperature sensors, moisture sensors, physiological sensors, energy sensors, and network sensors.

The device interface 102 includes an application layer, presentation layer, and/or data layer of a software or firmware application. The device interface 102 manages and facilitates electronic, electromechanical, and/or electromagnetic communications between the environment 101 and the retrieval and ranking system 104. In some examples, responsive to receiving signals via one or more components of the environment 101, the device interface 102 provides portions of the signals to one or more components of the retrieval and ranking system 104 and provides portions of output produced by components of the retrieval and ranking system 104 to one or more components of the environment 101. Such output includes digital data such as textual, graphical, or multimodal content. In some examples, the output provided by the device interface 102 to the environment 101 includes digital content (e.g., search results, recommendations, documents, videos, graphics, user interface elements, etc.) capable of being presented to the user via a graphical, audio, or multimodal user interface at one or more user devices 101A.

The retrieval and ranking system 104 includes an alignment and learning service 106, a first serving path 140, a second serving path 142, a filtering service 114, one or more entity data stores 144, and one or more item stores 146. The first serving path 140 and the second serving path 142 each include one or more machine learning models, such as deep learning models. Examples of machine learning models that are capable of being used in the first serving path 140 and/or second serving path 142 are described with reference to, e.g., FIG. 7A, FIG. 7B, and FIG. 7C.

The first serving path 140 includes an L1 service 118 (e.g., a retrieval model), and an L2 service 122 (e.g., a ranking model). The retrieval model of the L1 service 118 is a machine learning model that is optimized for relevance (e.g., probability of conversion, such as probability that a user will apply for a job after engaging with the job posting. The measure of conversion is variable depending upon the particular application of the retrieval and ranking system. In some examples, the measure of conversion is a probability that a user will view an online job posting and apply for the job. In other examples, the measure of conversion is a probability that a user will view an online description of a product or service and purchase or sign up for the product or service.

In some examples, the retrieval model of the L1 service 118 uses entity embeddings, item embeddings, and an embedding-based retrieval (EBR) technique to identify items that have features that are similar to features of an entity based on a pairwise comparison of the item embeddings to the entity embedding. In some examples, the retrieval model of the L1 service 118 is a bi-encoder. Bi-encoders independently generate embeddings for different inputs of a pair of inputs and then compare the embeddings of the inputs using, e.g., cosine similarity.

Entity as used herein refers to one or more persons or objects for which items may be served by a retrieval and ranking system. Examples of entities include users, companies, institutions, groups or cohorts, agents, devices, robots, or components of an environment (e.g., the environment 101). Item as used herein refers to a digital content item, such as a document, article, job posting, video, image, recording, comment, instruction, or multi-modal content item.

The ranking model of the L2 service 122 is a machine learning model that is optimized for multiple objectives including engagement, relevance and revenue. In some examples, the measure of revenue is a probability of a successful auction (e.g., that a highly-weighted item is viewed or interacted with by a user in an auction).

In some examples, the ranking model of the L2 service 122 is a machine learning model that is optimized for NLP tasks, such as sentence pair scoring and classification, using, e.g., a deep learning model such as a multi-layer perceptron (MLP) model. An MLP model contains multiple layers of fully connected neurons and uses nonlinear activation functions to learn complex patterns in data that a simpler linear model would not be able to accurately classify.

In some examples, the ranking model of the L2 service 122 includes a cross-encoder. Cross-encoders process pairwise inputs simultaneously (e.g., as a single input) through a deep neural network (e.g., a Transformer network) to produce an output value that indicates the similarity of the input pair. Examples of deep learning models are described with reference to, e.g., FIG. 7B. An example of a Transformer network is described with reference to, e.g., FIG. 7C.

The ranking model of the L2 service 122 often achieves better matching performance than the retrieval model of the L1 service 118. However, the ranking model of the L2 service 122 does not produce embeddings that can be indexed or efficiently compared using, e.g., cosine similarity. Thus, as described in more detail with reference to, e.g., FIG. 3, in some examples, the bi-encoder retrieval model of the L1 service 118 is an approximation of the cross-encoder ranking model of the L2 service 122. As described in more detail with reference to, e.g., FIG. 2, the retrieval model of the L1 service 118 provides efficient pairwise evaluations of items and entities that are capable of being performed on-processor to further improve latency.

The second serving path 142 includes an L2 service 126 (e.g., a ranking model). The ranking model of the L2 service 126 is similar to the ranking model of the L2 service 122 in architecture and function, except that, as described in more detail below, the input to the L2 service 126 is different from the input to the L2 service 122. As described in more detail below, the ranking model of the L2 service 126 functions as a counterfactual ranking model in that its output is used to evaluate the performance of the first serving path 140.

The alignment and learning service 106 includes an alignment component 108 and a learning component 110. The alignment component 108 provides automatic alignment of objectives between the retrieval and ranking models of the first serving path 140 and between the first serving path 140 and the second serving path 142. For instance, the alignment component 108 applies an alignment algorithm to output of the first serving path 140, e.g., L1-L2 subset 124, and output of the second serving path 142, e.g., L2 subset 128, to produce alignment data 134. In some examples, the alignment data 134 is computed using a counterfactual regret minimization algorithm that measures the opportunity lost (e.g., click, engagement, conversion, auction bid, etc.) due to misalignment between the first serving path 140 and the second serving path 142.

The learning component 110 provides online incremental learning of model training labels for the retrieval and ranking models of the first serving path 140 based on feedback 132. The feedback 132 is received in response to served item(s) 130 produced by the first serving path 140. The learning component 110 generates label updates 136, which are used to debias the retrieval and ranking models. In some examples, an unsupervised domain adaptation technique is used for selection debiasing of the retrieval model of the L1 service 118, the ranking model of the L2 service 126, and/or the ranking model of the L2 service 122 using, e.g., a reinforcement learning technique. A model training approach for the retrieval model of the L1 service 118 is described with reference to, e.g., FIG. 3, and additional examples of online learning are described therewith.

The filtering service 114 is included in some examples and omitted in other examples. The filtering service 114 includes an attribute-based matching (ABM) component. The ABM component performs rule- or heuristics-based attribute-by-attribute matching of values of selected attributes of entities and items. The ABM component functions as a coarse filter on a set of prospective items to be matched with an entity. For instance, in a job to prospective applicant matching use case, the ABM component could filter a set of available job postings based on, e.g., geographic region, such that job postings in geographic regions that do not match the location of the prospective applicant are automatically excluded from a filtered subset of the available job postings.

The entity store(s) 144 and item store(s) 146 include one or more data stores that store features of the entities and items to be evaluated by the retrieval and ranking system 104, respectively. Features include data, such as attributes, profile data, and metadata, that are useful for similarity computations, comparisons, and/or predictions. For instance, in a job to prospective applicant matching use case, entity features for an entity could include geographic location, job title, job description, educational experience, and historical information about the entity's interactions with various items. Item features for an item could include geographic location, job title, role description, educational requirements, and historical information about various entities' interactions with the item.

In operation, the retrieval and ranking system 104 receives entity data 112 from one or more components of the environment 101 via device interface 102. The entity data 112 includes information about an entity, such as a query, request, input, or context provided directly or indirectly by the entity via the environment 101 and the device interface 102.

The filtering service 114 uses the entity data 112 to identify features of the associated entity and generate filtered entity-item pairs 116. In some examples, the filtering service 114 performs attribute-based matching or another coarse filtering technique to identify items that have features that match the entity data 112 and associated features, and include the identified items in the filtered entity-item pairs 116. Entity-item pairs with items that do not match the entity data 112 and associated features according to the attribute-based matching or other coarse filtering technique are excluded from the filtered entity-item pairs 116. An entity-item pair 116 includes the entity data 112, associated entity features, and features of a matching item.

In the first serving path 140, filtering service 114 outputs the filtered entity-item pairs 116, and the filtered entity-item pairs 116 are provided to the L1 service 118. As shown by the arrows connecting the filtering service 114 to the L1 service 118, the filtered entity-item pairs 116 are separate inputs to the retrieval model of the L1 service 118, so that the retrieval model of the L1 service 118 generates separate respective embeddings for the entity and each item paired with the entity by the filtering service 114 (e.g., an entity embedding based on the entity data 112 and associated entity features obtained from entity store(s) 144, and, for each item paired with the entity, an item embedding based on the item features obtained from item store(s) 146).

The L1 service 118 generates an L1 subset 120. The L1 subset 120 incudes the top k items based on similarity between the entity embedding and each of the item embeddings, where k is a positive integer whose value is variable based on the requirements of a particular retrieval and ranking system. In some examples, the L1 service 118 uses, e.g., cosine similarity, to evaluate similarity of each item embedding to the entity embedding, and to identify items that have a requisite level of similarity to the entity. If an item has the requisite level of similarity to the entity, the item is paired with the entity data 112 and that entity-item pair is included in the top k items, in the L1 subset 120. Items that do not have the requisite level of similarity are excluded from the L1 subset 120. The requisite level of similarity is variable depending on the requirements or design of a particular retrieval and ranking system.

The L1 subset 120 is output by the L1 service 118 and provided as input to L2 service 122. As shown by the single arrow connecting the L1 service 118 to the L2 service 122, an entity-item pair of the L1 subset 120 is processed by the L2 service 122 as a single input (e.g., the entity data and the item data of the entity-item pair are combined or concatenated and processed simultaneously as one text string), so that the ranking model of the L2 service 122 generates a ranking score for each entity-item pair based on that input and not based on a comparison of two separate inputs. The ranking model of the L2 service 122 scores each input entity-item pair using an NLP-based text scoring or classification technique, ranks the items in order according to their respective ranking scores, and selects items for inclusion in served item(s) 130 based on the ranking. The number of items included in the served item(s) 130 is variable based on the requirements of a particular retrieval and ranking system. Items that are included in the served item(s) 130 are included in the L1-L2 subset 124. Items that are not included in the served item(s) 130 are excluded from the L1-L2 subset 124.

The served item(s) 130 are provided to the device interface 102, e.g., for further processing and/or presentation via the environment 101. The L1-L2 subset 124 is provided to the alignment component 108.

In the second serving path 142, filtering service 114 provides the filtered entity-item pairs 116 to the L2 service 126. As shown by the single arrow connecting the filtering service 114 to the L2 service 126, the filtered entity-item pairs 116 are processed by the L2 service 126 as a single input (e.g., the entity data and the item data of the entity-item pair 116 are combined or concatenated and processed simultaneously as one text string), so that the ranking model of the L2 service 126 generates a ranking score for each entity-item pair 116 based on that input and not based on a comparison of two separate inputs. The ranking model of the L2 service 126 scores each input entity-item pair 116 using an NLP-based text scoring or classification technique, ranks the items in order according to their respective ranking scores, and selects items for inclusion in L2 subset 128 based on the ranking. The number of items included in the L2 subset 128 is variable based on the requirements of a particular retrieval and ranking system. Items that are included in the L2 subset 128 are provided to alignment component 108. Items that are not included in the L2 subset 128 are not provided to the alignment component 108.

At the alignment component 108 of the alignment and learning service 106, the L1-L2 subset 124 produced by the first serving path 140 is evaluated in comparison to the L2 subset 128 produced by the second serving path 142. The L1-L2 subset 124 is created by the ranking model of the L1 service 122 based on the L1 subset 120, while the L2 subset 128 is created by the ranking model of the L2 service 126 based on the filtered entity-item pairs 116.

Because input to the ranking model of the L2 service 126 contains the entire set of items in the entity item-pairs 116 instead of just the items in the L1 subset 120, and the second serving path 142 does not contain multiple retrieval and ranking stages, the L2 subset 128 is considered the reference or “golden” standard that is used to evaluate the performance of the first serving path 140. As such, at the alignment component 108, the L2 subset 128 serves as the counterfactual in the counterfactual regret minimization algorithm. The output of first serving path 140 is compared to the output of the second serving path 142 using the counterfactual regret algorithm. The “regret” means that the algorithm measures the loss from not having used the “golden” pipeline (e.g., the second serving path 142) for the online inference (but instead using the first serving path 140, which includes the L1 approximation, e.g., the retrieval model of the L1 service 118).

In response to the application of the counterfactual regret minimization algorithm to the L1-L2 subset 124 and the L2 subset 128, the alignment component 108 outputs the alignment data 134. The alignment data 134 is provided to the first serving path 140 for use in backpropagation 138. Backpropagation 138 makes adjustments to model parameters and/or coefficient values associated with connections between the neurons in the ranking model of the L2 service 122 and the retrieval model of the L1 service 118 (e.g., via distillation) based on the alignment data 134, to minimize the error between values predicted by the model and known values (such as, in this case, values predicted by the ranking model of the L2 service 126).

At the learning component 110 of the alignment and learning service 106, feedback 132 is received from the environment 101 via the device interface 102 in response to the served item(s) 130. Feedback 132 includes, e.g., user interactions with and/or reactions to one or more of the served item(s) 130. The learning component 110 generates label updates 136 based on feedback 132. For instance, a label update 136 changes a positive label to a negative label for a given served item 130 if a user did not interact with or react to that served item 130 or changes a negative label to a positive label if the user did interact with or react to the served item 130. The label updates 136 are provided to the first serving path 140 for reinforcement learning at the ranking model of the L2 service 122 and the retrieval model of the L1 service 118.

As described below, in some examples, a teacher-student training technique is used to create the (student) retrieval model of the L1 service 118 using pseudo labels 139 generated by the (teacher) ranking model of the L2 service 122. Pseudo labels are labels that are predicted by a machine learning model as opposed to actual, ground-truth labels provided by, e.g., users or subject matter experts. This solves the issue of lacking training data for probability prediction modeling for L1 model and finally facilitates the retrieval model of the L1 service 118 available to on-processor (e.g., in-GPU) implementation while also, through the distillation from the teacher model, improving alignment. A real-time alignment between the student model and the teacher model is performed by computing the counterfactual regret. The output from the counterfactual regret measurement is backpropagated for fine-tuning and/or re-ranking of items.

The pseudo labels 139 are generated by the teacher model (e.g., the ranking model of the L2 service 122) and used to train the student model (e.g., the retrieval model of the L1 service 118). The two pipelines facilitate the automatic alignment capabilities. The first serving path 140 is the “live” serving path operating online and providing served item(s) 130 to the environment 101 via the device interface 102. The second serving path 142 is a “test” or counterfactual pipeline that does not provide items to the environment 101.

The second serving path 142 does not use the retrieval model of the L1 service 118 to determine the input to the L2 ranking model. Thus, the ranking model of the L2 service 126 performs the ranking based on the original item set (e.g., the filtered entity-item pairs 116) and not the L1 filtered set (e.g., the L1 subset 120). In some examples, the second serving path 142 is not performed online but only performed for a small amount of network traffic used for automatic alignment.

The examples shown in FIG. 1 and the accompanying description are provided for illustration purposes. This disclosure is not limited to the described examples.

FIG. 2 is a component-based flow diagram of an example method for retrieval and ranking in accordance with some examples of the present disclosure.

For instance, FIG. 2 illustrates a method 200, which includes operations performed via a retrieval and ranking system 201, including communications between components of the retrieval and ranking system 201.

The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the computing system components shown in FIG. 2. In other examples, portions of the method 200 are performed by one or more computing system components shown in FIG. 1, FIG. 3, FIG. 4, FIG. 5, one or more components of computing system 600 of FIG. 6, one or more machine learning models of FIG. 7A, FIG. 7B, and/or FIG. 7C, and/or retrieval and ranking system 850 of FIG. 8. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 2, the method 200 is represented by arrows connecting components of the retrieval and ranking system 201. Examples of computing systems including a retrieval and ranking system such as the retrieval and ranking system 201 shown in FIG. 2 are described with reference to, e.g., FIG. 6 and FIG. 8. The retrieval and ranking system 201 of FIG. 2 includes a first serving path 202, a second serving path 218, logs 209 and an alignment component 228. Components shown in FIG. 2 are capable of performing the same or similar functionality as described above, e.g., with reference to similarly named components shown in FIG. 1, alternatively or in addition to functionality described in more detail below.

In FIG. 2, a portion of the first serving path 202 including filtering service 206 and L1 service 210 is implemented in an on-processor environment 204. The on-processor environment 204 is an in-GPU (graphics processing unit) hardware environment, in some examples. However, the on-processor environment 204 is not limited to circuits initially created for rendering graphics. The on-processor environment 204 includes other types of specialized electronic circuits that are capable of efficiently handling data-intensive or computationally demanding tasks, in other examples.

In the on-processor environment 204, in some examples, the filtering service 205 performs attribute-based matching and the retrieval model of the L1 service 210 computes a dot product on entity embeddings and item embeddings. The entity embeddings and/or item embeddings may be pre-computed and stored in a memory that is accessible to the on-processor environment 204, such that at inference time, the on-processor environment 204 retrieves the appropriate embedding from memory and computes the dot product on the retrieved embeddings. The dot product represents a distance between the entity embedding and item embedding in an entity-item pair within an embedding space. The distance is used to identify and retrieve the top k items 212.

In FIG. 2, the L2 service 214 and the second serving path 218 are not implemented in the on-processor environment 204. In some examples, the L2 service 214 is implemented in a cloud-based environment (e.g., hosted or server-based) that is accessible to the first serving path 202, and the second serving path 218 is implemented in the same cloud-based environment or a different cloud-based environment. Thus, in FIG. 2, the filtering service 206 is implemented in the on-processor environment 204 and a duplicate or replica of the filtering service 206, filtering service 220, is implemented in the cloud-based environment of the serving path 218. In other examples, the filtering service 206 provides its output to both the L1 service 210 and the L2 service 224 (e.g., instead of replicating the filtering service in the cloud-based environment).

In FIG. 2, logs 209 store output of the first serving path 202 (e.g., served items 216) and output of the second serving path 218 (e.g., test item(s) 226). The logs 209 are accessed by alignment component 228 to perform the automatic real-time alignment using, e.g., counterfactual regret minimization as described herein.

In online inferencing operation of the first serving path 202, in response to entity data, e.g., a request, input, or query related to an entity, the filtering service 206 identifies N items 208 from a larger item set (e.g., tens or hundreds of millions of items), where the N items 208 potentially match the entity data, and N is a positive integer. In some examples, the value of N is in the range of millions of items (e.g., an order of magnitude smaller than the number of items in the larger item set to which the filtering service 206 is applied). The N items 208 are input to the L1 service 210. The L1 service outputs the top k items 212 of the N items 208, where k is less than N. In the first serving path 202, the filtering service 206 and the L1 service 210 cooperate in the on-processor environment 204 to produce the top k items 212 with low latency using, e.g., a hybrid retrieval index service. The top k items 212 are input to the L2 service 214, and the L2 service 214 outputs X served items 216, where X is less than k. The X served items 216 are served to online environment (e.g., environment 101) via the first serving path 202 and stored in logs 209.

In some examples, the second serving path 218 operates in a nearline or offline environment due to the higher latency requirements of the L2 service 224 processing N items 222 rather than the top k items 212. In the second serving path 218, in response to entity data, the filtering service 220 identifies N items 222 (or the filtering service 220 is omitted and the second serving path 218 obtains the N items 222 from the filtering service 206).

The N items 222 are input to the L2 service 224, and the L2 service 224 outputs Y test items 226, where Y is less than N. The Y test items 216 are not served to the online environment (e.g., environment 101). The Y test items 216 are stored in logs 209 for use by the alignment component 228. The value of Y is the same as the value of X (and both X and Y may be greater than or equal to one). However, the actual content of the items within the set of Y test items 226 may be different from the content of the items within the set of X served items 216. The differences in the contents of the two item sets, X served items 216 and Y test items 226, reflects the degree of alignment or misalignment between the first serving path 202 and the second serving path 218. The measurement of this alignment or misalignment is computed by alignment component 228 using, e.g., techniques described herein.

In some examples, a small percentage (e.g., less than ten percent) of network traffic is sent to both the first serving path 202 and the second serving path 218, while all (e.g., one hundred percent) of the network draft is sent to only the first serving path 202 and not to the second serving path 218. As such, the automatic alignment processes of alignment component 228 are performed using a small percentage of all of the network traffic rather than all of the network traffic. Thus, in these examples, the N items 208 and the N items 222 are identified for an entity request of that small percentage of network traffic (e.g., for a given entity request in the small “test” percentage of network traffic, the N items 208 and the N items 222 should be the same but the X served items 216 and Y test items 226 may be different. The goal of the alignment component 228 is to minimize the differences between the X served items 216 and Y test items 226 such that the X served items 216 matches the Y test items 226 as closely as possible.

The examples shown in FIG. 2 and the accompanying description are provided for illustration purposes. This disclosure is not limited to the described examples.

FIG. 3 is a component-based flow diagram of an example method for training a machine learning model for retrieval and ranking in accordance with some examples of the present disclosure.

For instance, FIG. 3 illustrates a method 300. The method 300 includes operations performed by, e.g., a model training component of the L1 service 118 and/or a model training component of the L2 service 122, described with reference to, e.g., FIG. 1.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the portions of the method 300 are performed by the computing system components shown in FIG. 3. In other examples, portions of the method 300 are performed by one or more computing system components shown in FIG. 1, FIG. 2, FIG. 4, FIG. 5, one or more components of computing system 600 of FIG. 6, and/or one or more components of computer system 800 of FIG. 8. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 3, the method 300 is represented by arrows connecting components of a computing system. Examples of computing systems capable of including training components for machine learning models such as shown in FIG. 3 are described with reference to, e.g., FIG. 6 and FIG. 8. Examples of machine learning model training are described with reference to, e.g., FIG. 7A.

The method 300 includes a first training flow 320 and a second training flow 322. The first training flow 320 trains an L2 model 304 using a supervised machine learning technique. The L2 model 304 is a ranking model, e.g., a ranking model of L2 service 122 or L2 service 214. In the first training flow 320, many instances of L2 training input 302 are used to train L2 model 304. An instance of L2 training input 302 includes entity features eₜ, item features iₜ, and an actual or ground-truth label lₐ (e.g., a label determined based on historical user interaction data). The label lₐ indicates whether there is a positive or negative relationship between the entity features eₜ and the item features iₜ. An example of a positive relationship is an online interaction of the entity with the item. An example of a negative relationship is a lack of interaction of the entity with the item.

In the first training flow 320, the entity features eₜ and item features iₜ are input to the input layer of the L2 model 304 (e.g., as single input containing both entity features eₜ and item features iₜ) and the label lₐ is input to evaluation block 306. In response to the combined (e.g., concatenated) training input eₜ, iₜ, the L2 model 304 generates a predicted label lₚ₁. The evaluation block 306 applies a loss function to the predicted label lₚ₁ and the actual label lₐ to compute an error e₁. The evaluation block 306 evaluates the error e₁ to determine whether to backpropagate the error e₁ and continue training the L2 model L2, or whether the error e₁ evaluation indicates that the L2 model 304 has converged (e.g., the differences between the predicted labels lₚ₁ and the actual labels actual label lₐ are minimized). When the L2 model 304 has converged, it is determined to be capable of predicting labels for previously unseen inputs (e.g., unlabeled combinations of entity features and item features).

In the second training flow 322, an L2 model 310 is a version of the L2 model 304 that has been trained according to the process just described or a similar process. The trained L2 model 304 receives instances of L2 inference input 308. An instance of L2 inference input 308 includes a combination of entity features e₁ and item features iᵢ(e.g., a single unlabeled input containing both entity features e₁ and item features iᵢ). The instances of entity features e₁ and item features iᵢ are different from the training instances used in the first training flow 320 (e.g., entity features eₜ and item features iₜ). In response to an instance of L2 inference input 308, the L2 model 310 outputs a predicted (or inferred) label lᵢ. The label lᵢ is considered a pseudo label or soft target because it is predicted by the L2 model 310 rather than established as a ground-truth.

The pseudo label lᵢ is combined with its corresponding instance of L2 reference input 308 (e.g., entity features e₁ and item features iᵢ) to form an L1 training input 312. Many instances of such L1 training input 312 are used to train an L1 model 314. The L1 model 314 is a retrieval model, e.g., a retrieval model of L1 service 118 or L1 service 210.

During training of the L1 model 314, the entity features e₁ and item features iᵢ are input to the input layer of the L1 model 314 (e.g., as separate inputs, not combined or concatenated into a single text string) and the pseudo label lᵢ is input to evaluation block 316. In response to the training inputs eᵢ, iᵢ, the L1 model 314 generates a predicted label lₚ₂. The evaluation block 316 applies a loss function to the predicted label lₚ₂ and the pseudo label lᵢ to compute an error e₁. The evaluation block 306 evaluates the error e₁ to determine whether to backpropagate the error e₂ and continue training the L1 model 314, or whether the error e₂ evaluation indicates that the L1 model 314 has converged (e.g., the differences between the predicted labels lₚ₂ and the pseudo labels lᵢ are minimized). When the L1 model 314 has converged, it is determined to be capable of predicting labels for previously unseen inputs (e.g., unlabeled combinations of entity features and item features).

In the second training flow 322, the L2 model 310 functions as a teacher model and the L1 model 314 as a student model in a model distillation technique. The model distillation technique is used to transfer learned knowledge (e.g., statistical correlations) from a larger, more complex model (e.g., the L2 model 310) to a smaller, less complex model (e.g., the L1 model 314). As a result, the L1 model 314 is capable of generating predictions more efficiently (e.g., easier to deploy, faster to run, and/or requiring fewer computational resources) than the L2 model 310 while still retaining the learned knowledge and predictive performance of the L2 model 310.

After training and during runtime operation, online learning techniques provided by, e.g., learning component 110, are used to help debias the L2 model 310 and the L1 model 314. For instance, if the L2 model 310 is incorrectly trained to label a low-relevance item as high relevance, then without online learning the L2 model 310 propagates the incorrect label to the L1 model 314, causing the L1 model 314 to provide an inaccurate prediction. However, with online learning, if the L2 model 310 is initially trained on an incorrect label, the incorrectly labeled item may be served but negative feedback from the user is used to incrementally adjust the predictions of the L2 model 310 and this new knowledge is distilled to the L1 model 314 so that subsequently the low-relevance item (or similar items) are not served.

Alternatively or in addition, if the L2 model 310 is incorrectly trained to label a high-relevance item as low-relevance, the item is unlikely to be shown to the user. However, with online learning, feedback from the user enables the L2 model 310 to adjust its predictions and these adjustments are distilled to the L1 model 314 so that subsequently the item (or similar items) may be correctly labeled as high-relevance and shown to the user.

The examples shown in FIG. 3 and the accompanying description are provided for illustration purposes. This disclosure is not limited to the described examples.

FIG. 4 is a component-based flow diagram of an example method for retrieval and ranking using an auction service in accordance with some examples of the present disclosure.

For instance, FIG. 4 illustrates a method 400. The method 400 includes operations performed by a retrieval and ranking system 401 and communications between components of the retrieval and ranking system 401.

The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the portions of the method 400 are performed by the computing system components shown in FIG. 4. In other examples, portions of the method 400 are performed by one or more computing system components shown in FIG. 1, FIG. 2, FIG. 3, FIG. 5, one or more components of computing system 600 of FIG. 6, and/or one or more components of computer system 800 of FIG. 8. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 4, the method 400 is represented by arrows connecting components of retrieval and ranking system 401. Examples of computing systems capable of including a retrieval and ranking system such as retrieval and ranking system 401 shown in FIG. 4 are described with reference to, e.g., FIG. 6 and FIG. 8. Components shown in FIG. 4 are capable of performing the same or similar functionality as described above, e.g., with reference to similarly named components shown in FIG. 1, FIG. 2, or FIG. 3, alternatively or in addition to functionality described in more detail below.

In FIG. 4, the retrieval and ranking system 401 includes a first serving path 402, a second serving path 418, logs 428, and an alignment component 430. The first serving path 402 includes a retrieval service 404 and an L2 auction service 414. The retrieval service 404 includes a filtering service 404 and an L1 auction service 410. In some examples, the retrieval service 404 includes a GPU-based retrieval system. The second serving path 418 includes a pacing service 420 and an L2 auction service 424.

In the first serving path, the L1 auction service 410 is similar to the L1 service 118, the L1 service 210, or the L1 model 314, except that the retrieval model of the L1 auction service 410 is additionally optimized for an auction (e.g., to identify items to maximize the success of the auction). In the example of FIG. 4, an auction is a time-limited retrieval and ranking service. The L1 auction service 410 is optimized for auction using, e.g., the distillation, alignment and/or online learning techniques described herein. The L2 auction service 414 is similar to the L2 service 122, the L2 service 214, or the L2 model 310, except that the ranking model of the L2 auction service 414 is optimized for auction.

In the second serving path 418, the pacing service 420 controls the amount of the weight value (or boost value, or bid) that is submitted by a given content provider (e.g., a potential source of items) to the auction, in order to ensure that the maximum amount (or budget) allocated to the content provider is not exceeded by the bid or is not exceeded too quickly in view of the amount of time remaining in the auction. As such, the pacing service 420 increases or decreases weight values (e.g., bid amounts) of bids by content providers for auctioned slots in accordance with their respective budgets.

The L2 auction service 424 is similar to the L2 auction service 414 except that the input to the L2 auction service 424 is different from the input to the L2 auction service 414.

In online operation, in response to a trigger, such as an input, query, or request related to an entity, the filtering service 406 is applied to a set of items (e.g., digital content items, such as job postings, etc., that are capable of being presented via user interface slots). The filtering service 406 produces a subset of the initial set of items, N items 408. In some examples, the initial set of items includes tens of millions of items or more, and N is an order of magnitude less than that, e.g., in the range of about a million items.

The pacing service 420 assigns weight values (e.g., bids or boost values) to items in accordance with the associated content provider budgets. The pacing service 420 provides the items and associated weight values as pacing data 422 to filtering service 406, L2 auction service 414, and L2 auction service 424, so that the weight values are taken into consideration during the filtering and ranking processes.

The N items 408 produced by filtering service 406 are provided to L1 auction service 410 in the first serving path 402 and also to L2 auction service 424 in the second serving path 418. At the L1 auction service 410, EBR is used to generate entity and item embeddings and compute a dot product for each entity embedding-item embedding pair. The entity embeddings and item embeddings are computed based on associated entity features and item features, as needed. Some embeddings, e.g., item embeddings, may be pre-computed and simply retrieved from memory, while other embeddings, e.g., entity embeddings, may be computed at runtime (e.g., based on the most current set of entity features).

In some examples, the dot product computation portion of the L1 auction service 410 is performed on-processor (e.g., in-GPU) while other portions of the L1 auction service 410, such as embedding computations, are performed outside the GPU. In some examples, item embeddings are precomputed and stored on-processor for fast retrieval and dot product computation at runtime. The output of the dot product computations is used to select the top k items 412, where k is less than N.

In the first serving path, the top k items 412 and associated pacing data 422 are provided to the L2 auction service 410. In the second serving path 418, the N items 408 and associated pacing data 422 are provided to the L2 auction service 424 (e.g., skipping the L1 auction service 410 in the second serving path 418).

The L2 auction service 414 ranks the top k items 412 and selects the X auction results 416 from among the ranked top k items 412, where X is less than k. The L2 auction service 424 ranks the N items 408 and selects the Y counterfactual auction results 426 from among the ranked N items 408, where Y is less than N.

In the L1 and L2 auction services, the pacing data 422 is included in the optimization objective. For instance, the L2 auction service 414 and the L2 auction service 424 aim to optimize the probability of engagement and maximize the weight value (e.g., bid) obtained via the pacing data 422. In some examples, the ranking scores output by the L2 auction services represent a probability of engagement multiplied by the weight value (e.g., pCTR*bid). The L1 auction service 410 is an approximation of the L2 auction service 414, e.g., appx (pCTR*bid).

The X auction results 416 and Y counterfactual auction results 426, including respective ranking scores produced by the L2 auction service 414 and the L2 auction service 424, are stored in logs 428 and provided to alignment component 430. Alignment component 430 compares the ranking scores produced by the L2 auction service 414 and the L2 auction service 424, e.g., by computing the regret based on the difference between the ranking scores.

The examples shown in FIG. 4 and the accompanying description are provided for illustration purposes. This disclosure is not limited to the described examples.

FIG. 5 is a flow diagram of an example method for retrieval and ranking in accordance with some examples of the present disclosure.

The method 500 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 500 are performed by the computing system components shown in FIG. 1, FIG. 2, FIG. 3, FIG. 4, FIG. 5, one or more components of computing system 600 of FIG. 6, one or more machine learning models of FIG. 7A, FIG. 7B, or FIG. 7C, and/or one or more components of computer system 800 of FIG. 8. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 510, a processing device provides entity-item pairs to a first machine learning model. The processing device receives a first subset of the entity-item pairs from the first machine learning model. The processing device provides the first subset of the entity-item pairs to a second machine learning model. The processing device receives first predictive output from the second machine learning model. The first predictive output is generated by the second machine learning model in response to the first subset of the entity-item pairs. In some examples, operation 510 is performed via a first serving path. In some examples, portions of operation 510 are performed by components of a first serving path as described with reference to, e.g., FIG. 1, FIG. 2, and/or FIG. 4.

In some examples, the subset of the entity-item pairs is generated by the first machine learning model using pseudo labels generated by the second machine learning model. In some examples, the first serving path generates and logs the first predictive output within a first computing environment and the second serving path generates and logs the second predictive output within a second computing environment different from the first computing environment.

At operation 520, via a second serving path, the processing device provides the entity-item pairs to the second machine learning model. The processing device receives second predictive output from the second machine learning model. The second predictive output is generated by the second machine learning model in response to the entity-item pairs. In some examples, the processing device logs the second predictive output. In some examples, operation 520 is performed via a second serving path. In some examples, portions of operation 520 are performed by components of a second serving path as described with reference to, e.g., FIG. 1, FIG. 2, and/or FIG. 4.

At operation 530, the processing device computes an alignment of a first objective of the first machine learning model with a second objective of the second machine learning model using the first predictive output and the logged second predictive output. In some examples, portions of operation 530 are performed by an alignment component as described with reference to, e.g., FIG. 1, FIG. 2, and/or FIG. 4.

At operation 540, the processing device uses the alignment to update the first machine learning model. In some examples, portions of operation 540 are performed by a backpropagation component as described with reference to, e.g., FIG. 1, FIG. 2, FIG. 3, and/or FIG. 4.

In some examples, the processing device provides unlabeled entity-item pairs to the second machine learning model, where the second machine learning model is trained according to a first objective. The processing device receives pseudo labels for the unlabeled entity-item pairs from the second machine learning model. The processing device trains the first machine learning model according to a second objective using the pseudo labels received from the second machine learning model.

In some examples, the processing device computes the alignment by determining a regret using the first predictive output and the second predictive output. The processing device uses the regret to align the first objective of the first machine learning model with the second objective of the second machine learning model.

In some examples, the processing device implements the first machine learning model on a graphics processing unit (GPU). The first predictive output is generated via the GPU. In some examples, the processing device implements an attribute-based matching (ABM) component on the GPU. The ABM component is used to generate a second subset of the entity-item pairs. The first machine learning model is applied to the second subset of the entity-item pairs to produce the first subset of the entity-item pairs.

In some examples, the first machine learning model includes an embedding-based retrieval (EBR) component on the GPU. The EBR component is used to generate the first predictive output via the GPU.

In some examples, the item embeddings for items of the entity-item pairs are stored on the GPU. An entity embedding for the entity of the entity-item pairs is computed. The entity embedding and the item embeddings are provided to the first machine learning model on the GPU.

In some examples, a boost value is obtained from a pacing service. The boost value is used as an input to at least one of generation of the first predictive output or generation of the second predictive output.

In some examples, the second machine learning model includes an auction service and the first machine learning model includes an approximation of the auction service.

In some examples, via the first serving path, the processing device receives feedback via a device in response to a presentation of a digital content item. The processing device modifies a pseudo label in response to the feedback. The modified pseudo label is used to update at least one of the second machine learning model or the first machine learning model.

In some examples, the entity-item pairs include a first number of digital content items, the first subset of the entity-item pairs includes a second number of digital content items, where the second number is lower than the first number, and the first predictive output includes a third number of digital content items, where the third number is lower than the second number.

In some examples, the alignment is used to control whether a digital content item of at least one of the first predictive output or the second predictive output is provided to an entity via a device.

The examples shown in FIG. 5 and the accompanying description are provided for illustration purposes. This disclosure is not limited to the described examples.

FIG. 6 is a block diagram of a computing system that includes retrieval and ranking in accordance with some examples of the present disclosure.

In the example of FIG. 6, a computing system 600 includes one or more user systems 610, a network 620, an application system 630, data resources and tools 650, a retrieval and ranking system 680, a data storage system 660, an event logging service 670, and an AI model service 690.

All or at least some components of retrieval and ranking system 680 are implemented at the user system 610, in some examples. For example, portions of retrieval and ranking system 680 are implemented directly upon a single client device such that communications involving applications running on user system 610 and retrieval and ranking system 680 occur on-device without the need to communicate with, e.g., one or more servers, over the Internet. Dashed lines are used in FIG. 6 to indicate that all or portions of retrieval and ranking system 680 are capable of being implemented directly on the user system 610, e.g., the user's client device. In some examples, both user system 610 and retrieval and ranking system 680 are implemented on the same computing device, in some examples. In other examples, all or portions of retrieval and ranking system 680 are implemented on one or more servers and in communication with user systems 610 via network 620. Components of the computing system 600 including the retrieval and ranking system 680 are described in more detail herein.

A user system 610 includes one or more computing devices. Examples of computing devices include a personal computing device, a server, a mobile computing device, a wearable electronic device, or a smart appliance. The user system 610 includes one or more software applications that a computing device is capable of executing alone or in combination with one or more other computing devices. Examples of software applications include an operating system or a front end of an online system. Many different user systems 610 are capable of being connected to network 620 at the same time or at different times. In some examples, different user systems 610 contain similar components as described in connection with the illustrated user system 610. In some examples, many different end users of computing system 600 interact with many different instances of application system 630 through their respective user systems 610, at the same time or at different times.

User system 610 includes a user interface 612. User interface 612 is installed on user system 610 or accessible to user system 610 via network 620. In some examples, user interface 612 includes a front end portion of a search application or retrieval and ranking system.

User interface 612 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 612 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 612 are shown in the drawings and described herein.

User interface 612 is capable of interacting with the retrieval and ranking system 680 and/or one or more application systems 630. For example, user interface 612 enables the user of a user system 610 to interact with the retrieval and ranking system 680 to create, edit, send, view, receive, process, and organize projects, tasks, plans, search queries, search results, content items, news feeds, and/or portions of online dialogs. In some examples, user interface 612 enables the user to input requests (e.g., queries) for various different types of information, to initiate user interface events, and to view or otherwise perceive output such as data and/or digital content produced by, e.g., an application system 630, retrieval and ranking system 680, content distribution service 638 and/or search engine 640. In some examples, user interface 612 includes a graphical user interface (GUI), a conversational voice/speech interface, a virtual reality, augmented reality, or mixed reality interface, and/or a haptic interface. User interface 612 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 612 include web browsers, command line interfaces, and mobile app front ends. User interface 612 as used herein includes application programming interfaces (APIs) in some examples.

Network 620 includes an electronic communications network. Network 620 is implemented on any medium or mechanism that provides for the exchange of digital data, signals, and/or instructions between the various components of computing system 600. Examples of network 620 include, without limitation, a Local Area Network (LAN), a Wide Area Network (WAN), an Ethernet network or the Internet, or a terrestrial, satellite or wireless link, or a combination of any number of different networks and/or communication links.

Application system 630 includes, for example, one or more online systems that provide social network services, general-purpose search engines, specific-purpose search engines, messaging systems, content distribution platforms, e-commerce software, enterprise software, or any combination of any of the foregoing or other types of software. Application system 630 includes any type of application system that provides or enables the retrieval of and interactions with one or more forms of digital content, including machine-generated content via user interface 612. In some examples, portions of retrieval and ranking system 680 are components of application system 630. In some examples, an application system 630 includes one or more of an entity graph 632 and/or knowledge graph 634, a user connection network 15315, a content distribution service 638, and/or a search engine 640. In other examples, application system 630 interacts with retrieval and ranking system 680 to control a physical machine or device, such as a vehicle or a robot.

In some examples, a front end portion of application system 630 operates in user system 610, for example as a plugin or widget in a graphical user interface of a web application, mobile software application, or as a web browser executing user interface 612. In an example, a mobile app or a web browser of a user system 610 transmits a network communication such as an HTTP request over network 620 in response to user input that is received through a user interface provided by the web application, mobile app, or web browser, such as user interface 612. A server running application system 630 receives the input from the web application, mobile app, or browser executing user interface 612, performs one or more operations using the input, and returns output to the user interface 612 using a network communication such as an HTTP response, which the web application, mobile app, or browser receives and processes at the user system 610.

In the example of FIG. 6, an application system 630 includes an entity graph 632 and/or a knowledge graph 634. Entity graph 632 and/or knowledge graph 634 include data organized according to graph-based data structures that are searchable or traversable via queries and/or indexes to determine relationships between entities. In some examples, entity graph 632 and/or knowledge graph 634 is used to compute various types of relationship weights, affinity scores, similarity measurements, and/or statistics between, among, or relating to entities.

Entity graph 632, knowledge graph 634 includes a graph-based representation of data stored in data storage system 660, described herein. For example, entity graph 632, knowledge graph 634 represents entities, such as users, organizations (e.g., companies, schools, institutions), content items (e.g., job postings, announcements, articles, comments, and shares), and computing resources (e.g., databases, models, applications, and services), as nodes of a graph. Entity graph 632, knowledge graph 634 represents relationships, also referred to as mappings or links, between or among entities as edges, or combinations of edges, between the nodes of the graph. In some examples, mappings between different pieces of data used by an application system 630 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 632, knowledge graph 634 are automatically re-generated or updated from time to time based on changes and updates to the stored data, e.g., updates to entity data and/or activity data. In some examples, entity graph 632, knowledge graph 634 refers to an entire system-wide entity graph or to only a portion of a system-wide graph. In some examples, entity graph 632, knowledge graph 634 refers to a subset of a system-wide graph, where the subset pertains to a particular user or group of users of application system 630.

Knowledge graph 634 includes a graph-based representation of data stored in data storage system 660, described herein. Knowledge graph 634 represents relationships, also referred to as links or mappings, between entities or concepts as edges, or combinations of edges, between the nodes of the graph. In some examples, mappings between different pieces of data used by application system 630 or across multiple different application systems are represented by the knowledge graph 634.

In some examples, knowledge graph 634 is a subset or a superset of entity graph 632. In some examples, knowledge graph 634 includes multiple different entity graphs 632 that are joined by cross-application or cross-domain edges. In some examples, knowledge graph 634 joins entity graphs 632 that have been created across multiple different databases or across different software products. In some examples, the entity nodes of the knowledge graph 634 represent concepts, such as product surfaces, verticals, or application domains. In some examples, knowledge graph 634 includes a platform that extracts and stores different concepts that is used to establish links between data across multiple different software applications. Examples of concepts include topics, industries, and skills. As with other portions of entity graph 632, knowledge graph 634 is usable to compute various types of relationship weights, affinity scores, similarity measurements, and/or statistical correlations between or among entities and/or concepts.

In the example of FIG. 6, application system 630 includes a user connection network 636. User connection network 636 includes, for instance, a social network service, professional social network system and/or other social graph-based applications. Content distribution service 638 includes, for example, a feed, chatbot or chat-style system, or a messaging system, such as a peer-to-peer messaging system that enables the creation and exchange of messages between users of application system 630 and the application system 630. Search engine 640 includes a search engine that enables users of application system 630 to input and execute search queries to retrieve information from one or more sources of information, such as user connection network 636, entity graph 632, knowledge graph 634, one or more data stores of data storage system 660, or one or more data resources and tools 650.

In the example of FIG. 6, application system 630 includes a content distribution service 638. The content distribution service 638 includes a data storage service, such as a web server, which stores digital content items, and transmits digital content items to users via user interface 612. In some examples, content distribution service 638 processes requests from, for example, application system 630 and/or retrieval and ranking system 680, and distributes digital content items to user systems 610 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 638 is part of application system 630. In other examples, content distribution service 638 interfaces with application system 630 and/or retrieval and ranking system 680, for example, via one or more application programming interfaces (APIs).

In the example of FIG. 6, application system 630 includes a search engine 640. Search engine 640 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 640 is used to retrieve data in response to user input and/or system-generated queries, by executing queries on various data stores of data storage system 660 and/or data resources and tools 650, or by traversing entity graph 632, knowledge graph 634.

Data resources and tools 650 include computing resources, such as data stores, databases, embedding-based retrieval mechanisms, code generators, etc., that are capable of being used to operate a retrieval and ranking system. Data resources and tools 650 include computing resources that are internal to application system 630 or external to application system 630. Examples of data resources and tools 650 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 650 enables a retrieval and ranking system to access the data resource or tool, for example by providing an application programming interface (API). Each data resource or tool 650 includes a monitoring service that periodically generates, publishes, or broadcasts availability and/or other performance metrics associated with the data resource, in some examples. A data resource or tool 650 provides a set of APIs that are used by a retrieval and ranking system to access the data resource or tool, obtain output from the data resource, and/or obtain performance metrics for the data resource or tool, in some examples.

Data storage system 660 includes data stores and/or data services that store digital data received, used, manipulated, and produced by application system 630 and/or retrieval and ranking system 680, including contextual data, state data, prompts and/or prompt templates for generative artificial intelligence models or large language models, user inputs, system-generated outputs, metadata, attribute data, activity data. Databases or data stores that are capable of being used in some of the described examples include but are not limited to vector databases, graph databases, relational databases, and key-value stores.

In the example of FIG. 6, data storage system 660 includes various data stores that store, for example, entity data, context data, prompts, embeddings, etc. A data store includes include a volatile memory such as a form of random access memory (RAM) and/or persistent memory, which can be available on user system 610 or another device (e.g., one or more servers) for storing state data generated at the user system 610 or an application system 630. In some examples, a separate, personalized version of each or any data store is created for each user such that data is not shared between or among the separate, personalized versions of the data stores.

In some examples, data storage system 660 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 660 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 660 resides on one or more persistent and/or volatile storage devices that reside within the same local network as other devices of computing system 600 and/or in a network that is remote relative to other devices of computing system 600. Thus, although depicted as being included in computing system 600, portions of data storage system 660 are part of computing system 600 or accessed by computing system 600 over a network, such as network 620, in some examples.

Event logging service 670 captures and records activity data generated during operation of application system 630 and/or retrieval and ranking system 680, including user interface events generated at user systems 610 via user interface 612, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 630 via a user system 610 enters input or clicks on a user interface element, such as a workflow element, or a user interface control element such as a view, comment, share, or reaction button, or uploads a file, or inputs a query, or scrolls through a feed, etc., event logging service 670 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 670 stores the corresponding event data in a log. Event logging service 670 generates a data stream that includes a record of real-time event data for each user interface event that has occurred. Event data logged by event logging service 670 is pre-processed and anonymized as needed so that it is capable of being used as context data to, for example, configure one or more instructions for one or more artificial intelligence models (e.g., large language models), or to modify weights, affinity scores, or similarity measurements that are assigned by the retrieval and ranking system to search results or data resources.

Retrieval and ranking system 680 includes any one or more of the components, features, or functions described herein with respect to a retrieval and ranking system. For example, retrieval and ranking system 680 includes components of an L1 service, an L2 service, a filtering service, an alignment and learning service, and/or an auction service, as described herein.

AI model service 690 includes one or more artificial intelligence-based models, such as large language models and/or other types of machine learning models including discriminative and/or generative models, neural networks, probabilistic models, statistical models, transformer-based models, and/or any combination of any of the foregoing. AI model service 690 enables retrieval and ranking systems to access to these models, for example by providing one or more application programming interfaces (APIs). AI model service 690 includes a monitoring service that periodically generates, publishes, or broadcasts latency and/or other performance metrics associated with the models. In some examples, AI model service 690 provides a set of APIs that are used by a retrieval and ranking system to obtain performance metrics for large language models and/or other machine learning models.

While not specifically shown, it should be understood that any of user system 610, application system 630, data resources and tools 650, data storage system 660, event logging service 670, retrieval and ranking system 680, and AI model service 690 includes an interface embodied as computer programming code stored in computer memory that when executed causes a computing device to enable bidirectional communication with any other of user system 610, application system 630, data resources and tools 650, data storage system 660, event logging service 670, retrieval and ranking system 680, and AI model service 690 using a communicative coupling mechanism. Examples of communicative coupling mechanisms include network interfaces, inter-process communication (IPC) interfaces and application program interfaces (APIs).

Each of user system 610, application system 630, data resources and tools 650, data storage system 660, event logging service 670, retrieval and ranking system 680, and AI model service 690 is implemented using one or more computing devices that are communicatively coupled to electronic communications network 620. Any of user system 610, application system 630, data resources and tools 650, data storage system 660, event logging service 670, retrieval and ranking system 680, and AI model service 690 are capable of being bidirectionally communicatively coupled by network 620. User system 610 as well as other different user systems (not shown) are bidirectionally communicatively coupled to application system 630 and/or retrieval and ranking system 680, in some examples.

Examples of users of user system 610 include an administrator or end user of application system 630 or retrieval and ranking system 680. User system 610 is configured to communicate bidirectionally with any of application system 630, data resources and tools 650, data storage system 660, event logging service 670, retrieval and ranking system 680, and AI model service 690 over network 620.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application system 630, data resources and tools 650, data storage system 660, event logging service 670, retrieval and ranking system 680, and AI model service 690 are implemented using computer software, hardware, or software and hardware, and include combinations of automated functionality, data structures, and digital data, which are represented schematically in the figures. User system 610, application system 630, data resources and tools 650, data storage system 660, event logging service 670, retrieval and ranking system 680, and AI model service 690 are shown as separate elements in FIG. 15 for ease of discussion but, except as otherwise described, the illustration is not meant to imply that separation of these elements is required. The illustrated systems, services, and data stores (or their functionality) of each of user system 610, application system 630, data resources and tools 650, data storage system 660, event logging service 670, retrieval and ranking system 680, and AI model service 690 are capable of being divided over any number of physical systems, including a single physical computer system, and are capable of communicating with each other in any appropriate manner.

In the example of FIG. 8, portions of retrieval and ranking system 680 that are capable of being implemented on a front end system, such as one or more user systems, and portions of retrieval and ranking system 680 that are capable of being implemented on a back end system such as one or more servers, are collectively represented as retrieval and ranking system 850 for ease of discussion only. In some examples, portions of retrieval and ranking system 680 are not required to be implemented all on the same computing device, in the same memory, or loaded into the same memory at the same time. In some examples, access to portions of retrieval and ranking system 680 is limited to different, mutually exclusive sets of user systems and/or servers. In some examples, a separate, personalized version of retrieval and ranking system 680 is created for each user of the retrieval and ranking system 680 such that data is not shared between or among the separate, personalized versions of the retrieval and ranking system 680. Certain portions of retrieval and ranking system 680 are capable of being implemented on user systems while other portions of retrieval and ranking system 680 are capable of being implemented on a server computer or group of servers. In some examples, one or more portions of retrieval and ranking system 680 are implemented on user systems. Retrieval and ranking system 680 is entirely implemented on user systems, e.g., client devices, in some examples. In some examples, a version of retrieval and ranking system 680 is embedded in a client device's operating system or stored at the client device and loaded into memory at execution time.

The examples shown in FIG. 6 and the accompanying description, above are provided for illustration purposes. This disclosure is not limited to the described examples.

FIG. 7A, FIG. 7B, and FIG. 7C are block diagrams of examples of machine learning models that are usable by and/or included in a retrieval and ranking system in accordance with some examples of the present disclosure.

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation (e.g., calibration and validation), and application. Data preparation includes obtaining and aggregating model input data. The preparation of training data includes labeling the aggregated data, in some examples. Training data includes structured data, unstructured data, text, multimodal data, or any combination of any of the foregoing. Model training includes setting values of hyperparameters, determining performance metrics, adjusting weights of the machine learning model in response to the training data, evaluating the performance metrics, and parameter tuning. Application includes applying the trained machine learning model to the real-world environment, e.g., in a specific use case using data not included in the training data (e.g., unlabeled data). The application phase is referred to as inferencing or inference time, in some examples.

In FIG. 7A, a machine learning modeling system 700 includes a machine learning model 706, a modeling and calibration subsystem 702, and a model validation subsystem 704. The machine learning model 706 is any type or combination of one or more machine learning models, such as any of the types of machine learning models shown in FIG. 7B, and FIG. 7C and/or any other types or combinations of machine learning models.

The modeling and calibration subsystem 702 receives model input, such as input feature sets, embeddings, digital content, or prompts. The model input is engineered to train the machine learning model 706 to perform one or more tasks, such as discriminative tasks like classification or scoring and/or generative tasks such as content generation tasks. Modeling and calibration subsystem 702 includes a data set creation component 703, a model training component 705, and a model calibration component 707.

Data set creation component 703 divides the model input, e.g., input feature sets, into one or more training data sets and one or more validation data sets, e.g., training data set 709 and validation data set 711. Model training component 705 and model calibration component 707 cooperatively execute a training process. In some examples, the training process causes the machine learning model 706 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model is used to generate predictive output (e.g., scores, labels, or other output) based on subsequent model input.

One or more different approaches are used to train the machine learning model 706, for example, supervised machine learning, semi-supervised machine learning, or unsupervised machine learning. In supervised machine learning, the set of training data includes indications of expected model output coupled with respective model input; for example, ground-truth labeled data samples. In some examples, an instance of training data for supervised learning includes a model input (e.g., a set of features) and an associated expected output (e.g., a classification label), where the expected output is human curated or machine-generated. In some examples, an instance of training data for supervised machine learning includes a digital image and a title or caption for the image that describes the contents of the image. In unsupervised machine learning, the training examples are unlabeled. In unsupervised machine learning, a machine learning algorithm such as a clustering algorithm is used to identify similarities among data samples and create clusters or groupings of similar data using one or more similarity criteria. In some examples, unsupervised learning is used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 705 applies machine learning model 706 to training data set 709 iteratively and adjusts the value of one or more model parameters and/or feature coefficients of the machine learning model 706 based on the processing of the training data set 709 by the model 706 until the difference between the predicted model output generated by the machine learning model 706 and the expected model output evidenced by the training data set 709 satisfies (e.g., meets or exceeds) model performance criteria 708. When the model performance criteria 708 are satisfied, modeling and calibration subsystem 702 ends the model training process and produces a trained machine learning model 706.

Model validation subsystem 704 applies a model validation process to the trained machine learning model 706 produced by modeling and calibration subsystem 702. Model validation subsystem 704 uses the validation data set 711 to determine whether model validation criteria 710 are satisfied (e.g., met or exceeded). In some examples, the validation data set 711 is created by setting aside a portion of the training data set 709 until after training, such that the validation data set 711 is used to compare and evaluate the difference between the predictive output produced by the trained model to the expected model output evidenced by the set-aside portion of the training data set 709.

A validated machine learning model 706 is used for inferencing, e.g., to generate predictive output, e.g., labels, scores, or other content, in response to model input. Alternatively or in addition, the output produced by the validated machine learning model 706 is stored for future use (e.g., for access or lookup by one or more downstream processes, systems, or services).

There are many different types and configurations of machine learning models. Illustrative, nonlimiting examples of some of the different types of machine learning models are shown in FIG. 7B and FIG. 7C, described below. The AIs, models, and AI model services described herein are capable of including or using any of the various types of machine learning models, including but not limited to one or more of the types of models shown in FIG. 7B and FIG. 7C.

The examples shown in FIG. 7A and the accompanying description, above are provided for illustration purposes. This disclosure is not limited to the described examples.

FIG. 7B is a block diagram of a machine learning model that is capable of being used by and/or included in a retrieval and ranking system in accordance with some examples of the present disclosure.

A specific example of a machine learning model is a deep neural network. Some machine learning models, such as multi-task models, include multiple interconnected deep neural networks. In the example of FIG. 7B, a machine learning system 730 includes a deep neural network 734. The deep neural network 734 is configured via training, calibration, and validation processes such as those described with reference to, e.g., FIG. 7A. Some examples of the deep neural network 734 are configured as a discriminative model and/or a generative model. In some examples, a deep neural network 734 performs both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier functions (e.g., ramp, or Rectified Linear Unit (ReLU)).

The input layer of a deep neural network receives and processes the model input, which includes raw data and/or pre-processed data such as aggregations, derivations, embeddings or vector representations of raw data. In some examples, the output of a layer of the neural network is connected to and used as the input to one or more other layers, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values are adjusted so that the outputs of some nodes or layers influences the final output more or less than the outputs of other nodes or layers, in some examples. The output layer of the neural network produces the final predictive output, which is made accessible to one or more downstream models, applications, systems, operations, processes or services.

Backpropagation is an example of a method that is often used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) is often used in backpropagation.

In some examples, recommendation systems use deep learning models to generate predictive output and use the predictive output to configure or control one or more downstream operations. In some examples, recommendation systems compute statistical or probabilistic predictions that are used to select, rank, or sort digital content items for presentation to users via electronic devices. Examples of downstream operations that are capable of using the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In the example of FIG. 7B, the deep neural network 734 includes an input layer 735, one or more hidden layers 736, and an output layer 737. The input layer 735 receives one or more batches of model input 723 (e.g., input feature sets X). In some examples, the input layer 735 includes a number of nodes that corresponds to the number of input features in a given input feature set X. The output of the input layer 735 becomes the input to the one or more hidden layers 736. The output of the one or more hidden layers 736 becomes the input to the output layer 737. The output layer 737 outputs the final predictive output 738. In some examples, each of the layers of the deep neural network 734 is fully connected in the sense that the output of each node of each layer is connected to the input of each node of the next subsequent layer. In other examples, the deep neural network 734 includes portions that are not fully connected.

The deep neural network 734 is capable of being configured and implemented as a network service. In some examples, the deep neural network 734 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the deep neural network 734 and/or its output are hosted on one or more servers and/or data storage devices for accessibility to one or more requesting processes, systems, devices, frameworks, or services.

The input feature set X includes numerical features, categorical features, quantitative values, qualitative values, raw features, compressed representations of raw features (e.g., vector representations or embeddings), natural language, and/or other forms of digital content. Embedding refers to a numerical representation of a set of features, in some examples. An embedding encodes information, e.g., a set of features associated with an entity and/or attribute, relative to an embedding space. Embeddings and embedding spaces are generated by artificial intelligence (AI) models. An embedding is often expressed as a vector, where each dimension of the vector includes a numerical value that is an integer or a real number (e.g., a floating point value). The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some examples, train as used herein refers to an iterative process of applying an AI algorithm to one or more sets of training data, analyzing the output of the AI model in comparison to expected model output using a loss function (also referred to as a cost function or error function), adjusting values of one or more parameters and/or coefficients of the AI model, and repeating the process until the difference between the actual model output and the expected model output falls within an acceptable range of error or tolerance.

Embedding-based retrieval (EBR) is a method of searching for similar digital content, such as documents or portions of documents. Embedding-based retrieval involves converting digital data, e.g., sets of features, to embeddings and then using a similarity algorithm, such as nearest-neighbor search or cosine similarity, to identify embeddings that are similar to one another. Match or map refers to an exact match or an inexact match, in various examples. Match or map refers to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of relevance, similarity, or compatibility is set lower or higher for different types of matching or mapping, in some examples.

In response to an instance of feature set X, deep neural network 734 computes and outputs a predictive output 738. The predictive output 738 is stored in a data storage for subsequent lookup or provided to one or more downstream systems, processes, devices, frameworks, and/or services.

The deep neural network 734 is configured and implemented as a network service, in some examples. The deep neural network 734 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 706 and/or its output are hosted on one or more servers and/or data storage devices for accessibility to one or more requesting processes, systems, devices, frameworks, or services.

The examples shown in FIG. 7B and the accompanying description, above are provided for illustration purposes. This disclosure is not limited to the described examples.

FIG. 7C is a block diagram of a machine learning model that is capable of being used by and/or included in a retrieval and ranking system in accordance with some examples of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. In some examples, an encoder transforms a sentence or an image into a sequence of numbers. A second neural network known as the decoder takes the output of the encoder (e.g., the encoded version of the model input) and decodes it. In some examples, a decoder transforms the sequence of numbers created and output by the encoder into a translated sentence or another form of output.

A specific example of an encode-decoder model is a transformer model. A transformer model is a deep neural network encoder-decoder model that uses a technique called attention or self-attention to detect relationships and dependencies among data elements in a sequence. Transformer models are capable of being used to perform various natural language processing (NLP) tasks and other machine learning tasks, such as generating content based on input attributes or tokens. In some examples, the attention mechanism facilitates the detection of relationships and dependencies between words and phrases.

In the example of FIG. 7C, a machine learning system 740 includes a transformer model 742. The transformer model 742 is constructed using a neural network-based machine learning model architecture. In some examples, the neural network-based architecture includes one or more self-attention layers (e.g., multi-head attention layer 745, masked multi-head attention layer 755, and multi-head attention layer 757) that allow the model to assign different weights to different features included in the model input. Alternatively, or in addition, the neural network architecture includes feed-forward layers (e.g., feed-forward layer 747 and feed-forward layer 759) and residual connections (e.g., add & norm layer 746, add & norm layer 748, add & norm layer 756, add & norm layer 758, add & norm layer 760) that allow the model to machine-learn complex data patterns including relationships between different states, actions, and rewards in multiple different contexts. In some examples, transformer model 742 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 7C, transformer model 742 feeds embedded subsequences 750 into encoder 744 and decoder 754. For example, transformer model 742 feeds inputs of embedded subsequences 750 into multi-head attention layer 745 of encoder 744. In some examples, inputs of embedded subsequences 750 are a series of tokens and the output of the encoder (e.g., encoder output representation 752), is a fixed-dimensional representation for each of the tokens of embedded subsequences 750 including an embedding for inputs of embedded subsequences 750. Transformer model 742 feeds encoder output representation 752 and outputs of embedded subsequences 750 into decoder 754 which generates a sequence of tokens based on encoder output representation 752 and the input embeddings. While a specific architecture of encoder 744 and decoder 754 is shown for simplicity, as explained above, the exact number and arrangement of layers of each type as well as the hyperparameter values used to configure the model are determined based on the requirements of a particular design or implementation. Therefore, in some examples, transformer model 742 includes different numbers, arrangements, and types of layers, such that each input token of embedded subsequences 750 is fed through the layers of transformer model 742 and is dependent on other input tokens of embedded subsequences 750.

Transformer model 742 illustrates a generic encoder/decoder model for simplicity. In such a model, encoder 744 encodes the input into a fixed-length vector (e.g., encoder output representation 752) and decoder 754 decodes the fixed-length vector into an output sequence. Encoder 744 and decoder 754 are trained together to maximize the conditional log-likelihood of the output given the input. Once trained, encoder 744 and decoder 754 are capable of generating output given an input sequence or scoring a pair of input-output sequences based on their probability of coexistence.

As shown in FIG. 7C, encoder 744 includes multi-head attention layer 745, add & norm layer 746, feed-forward layer 747, and add & norm layer 748. Multi-head attention layer 745 receives inputs of embedded subsequences 750 and computes output representations for each of the input tokens of embedded subsequences 750 based on the inputs of embedded subsequences 750. For example, multi-head attention layer 745 converts each input token of embedded subsequences 750 into queries, keys, and values using query, key, and value matrices. Multi-head attention layer 745 computes the output representation of the input tokens of embedded subsequences 750 as the weighted sum of the values of all of the input tokens of embedded subsequences 750. Multi-head attention layer 745 computes the weights for the weighted sum by applying a compatibility function to the corresponding key and query for the value. For example, multi-head attention layer 745 uses a scaled dot product on the key and query of an input token to determine a weight to apply to a value of the input token. Multi-head attention layer 745 includes multiple attention blocks which each compute an output representation for the input token. Multi-head attention layer 745 aggregates the output representations of these attention blocks to generate a final output representation for multi-head attention layer 745.

Transformer model 742 feeds the output representation generated by multi-head attention layer 745 and residual connections from the inputs of embedded subsequences 750 into add & norm layer 746. By including these residual connections, transformer model 742 ensures that it does not “forget” features of embedded subsequences 750 during training. Forgetting in the context of machine learning refers to a phenomenon that occurs as the model continues to be sequentially trained on different datasets over time. Because the model continually adjusts the values of feature coefficients as it is trained on subsequent training datasets, these continuous adjustments of the feature coefficient values is capable of causing the influence of the datasets used earlier in training on those coefficient values to be lost or diluted.

Add & norm layer 746 sums the output representation generated by multi-head attention layer 745 and the residual connections from inputs of embedded subsequences 750 and applies a layer normalization to the result. In some examples, the add & normal layers also apply a SoftMax function to generate action probabilities for the inputs of embedded subsequences 750. For example, add & norm layer 746 generates estimated probabilities \hat{p}(aₖ|s), where aₖ is the action policy and s is the state features.

Transformer model 742 feeds the normalized output of add & norm layer 746 into feed-forward layer 747. Feed-forward layer 747 is a feed-forward network that receives the normalized output, feeds it through the hidden layers of feed-forward layer 747, and then feeds the output of feed-forward layer 747 into add & norm layer 748. Feed-forward layer 747 processes the information received from add & norm layer 746 and updates the hidden layers of feed-forward layer 747 based on the information (e.g., during training) and/or generate an output based on the hidden layers processing the information (e.g., during evaluation and/or inference). For example, during training, transformer model 742 updates the weights of the hidden layers of feed-forward layer 747 based on the inputs and the loss of the transformer system. Further details with regard to the loss of the transformer system as well as training objectives and metrics are discussed below. As an alternative example, during evaluation and/or inference, the weights of the hidden layers of feed-forward layer 747 are used to determine the output representation 752 of each of the input tokens of embedded subsequences 750.

Transformer model 742 feeds the output of feed-forward layer 747 into add & norm layer 748 as well as residual connections from the output of add & norm layer 746. Add & norm layer 748 sums the output of feed-forward layer 747 with the residual connections from add & norm layer 746 and applies a layer normalization to the result to generate encoder output representation 752. Transformer model 742 feeds encoder output representation 752 into multi-head attention layer 757 of decoder 754 as explained below.

Masked multi-head attention layer 755 receives outputs of embedded subsequences 750 and computes representations for each of the output tokens of embedded subsequences 750 based on masked outputs of embedded subsequences 750. For example, masked multi-head attention layer 755 computes representations for each of the output tokens of embedded subsequences 750 based on previous output tokens while masking future output tokens. Masked multi-head attention layer 755 therefore only computes representations using tokens that come before the token masked multi-head attention layer 755 is trying to predict.

Transformer model 742 feeds the representation generated by masked multi-head attention layer 755 and residual connections from the outputs of embedded subsequences 750 into add & norm layer 756. Add & norm layer 756 sums the representation generated by masked multi-head attention layer 755 and the residual connections from outputs of embedded subsequences 750 and applies a layer normalization to the result.

Transformer model 742 feeds the normalized output of add & norm layer 756 into multi-head attention layer 757. Multi-head attention layer 757 receives the normalized output of add & norm layer 756 as well as encoder output representation 752 from encoder 744 and generates a representation based on both.

Transformer model 742 feeds the representation generated by multi-head attention layer 757 and residual connections from the output of add & norm layer 756 into add & norm layer 758. Add & norm layer 758 sums the representation generated by multi-head attention layer 757 and the residual connections from the output of add & norm layer 756 and applies a layer normalization to the result.

Transformer model 742 feeds the normalized output of add & norm layer 758 into feed-forward layer 759. Feed-forward layer 759 is a feed-forward network that receives the normalized output, feeds it through the hidden layers of feed-forward layer 759, and then feeds the output of feed-forward layer 759 into add & norm layer 769. Feed-forward layer 759 processes the information received from add & norm layer 758 and updates the hidden layers of feed-forward layer 759 based on the information (e.g., during training) and/or generate an output based on the hidden layers processing the information (e.g., during evaluation and/or inference). For example, during training, transformer model 742 updates the weights of the hidden layers of feed-forward layer 759 based on the inputs and the loss of the transformer system. Further details with regard to the loss of the transformer system as well as training objectives and metrics are discussed below. As an alternative example, during evaluation and/or inference, the weights of the hidden layers of feed-forward layer 759 are used to determine the output of feed-forward layer 759.

Transformer model 742 feeds the output of feed-forward layer 759 into add & norm layer 760 as well as residual connections from the output of add & norm layer 758. Add & norm layer 760 sums the output of feed-forward layer 759 with the residual connections from add & norm layer 758 and applies a layer normalization to the result to generate an output.

Transformer model 742 generates output probabilities 762 from the output of add & norm layer 760. For example, transformer model 742 applies a linear transformation and a SoftMax function to the output of add & norm layer 760 to generate a normalized vector of output probabilities 762.

In some examples, such as during training, transformer model 742 determines a loss for the system based on output probabilities 762. In some examples, transformer model 742 uses deep quantile regression for training. In such an example, output probabilities 762 includes a mean prediction probability and estimations for the upper and lower bounds of the range of prediction such that output probabilities 526 includes an uncertainty range. In one example, the loss function of transformer model 742 using deep quantile regression is represented by the following equation:

$$ℒ ( {ξ}_{i} \vert α ) = \{ \begin{matrix}{αξ}_{i} if {ξ}_{i} \geq 0 \\ ( α - 1 ) {ξ}_{i} if {ξ}_{i} < 0\end{matrix} ,$$

where α is the required quantile (a value between 0 and 1 representing the desired quantile) and ξᵢ=yᵢ−f(xᵢ), where f(xᵢ) is the mean predicted by output probabilities 762, yᵢ are the outputs of embedded subsequences 750 and xᵢ are the inputs of embedded subsequences 750. The loss over the entirety of a dataset of embedded subsequences 750 where embedded subsequences 750 has a length of N is capable of being represented by the following equation:

$$ℒ ( y , f \vert α ) = \frac{1}{N} {Σ}_{i = 1}^{N} ℒ ( {y}_{i} - f ( {x}_{i} ) \vert α ) .$$

In such examples, output probabilities 762 includes three values: a mean prediction, a lower bound quantile, and an upper bound quantile. In some examples, transformer model 742 uses upper confidence bound or Thompson sampling. In some examples, transformer model 742 determines model output 764 based on the mean prediction, the lower bound quantile, and the upper bound quantile based on upper confidence bound and/or Thompson sampling.

In some examples, transformer model 742 is trained to optimize the model parameters with trajectory-specific normalizations using cross-entropy loss. For example, transformer model 742 uses a loss function represented by the following equation:

$$L ( θ ) = \frac{1}{{N}_{t r a j}} {Σ}_{i}^{{N}_{t r a j}} {Σ}_{t = 1}^{{T}_{i}} {w}_{i} {Σ}_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some examples, transformer model 742 uses trajectory-wise normalization. In some examples, the add & norm layers of transformer model 742 normalize the weights according to the following equation:

$${w}_{i} = \frac{1}{{T}_{i}} ,$$

where Tᵢ is the length of trajectory i. In some examples, transformer model 742 uses global normalization. In some examples, the add & norm layers of transformer model 742 normalize the weights according to the following equation: wᵢ=c, where c is a positive scalar. In some examples, the scalar c is predetermined.

Language models, including large language models and other generative models, are capable of being implemented using transformer models. A generative model is commonly constructed using a neural network-based machine learning model architecture. In some examples, the neural network-based architecture includes one or more input layers that receive task descriptions (or prompts), generate one or more embeddings based on the task descriptions, and pass the one or more embeddings to one or more other layers of the neural network. In other examples, the one or more embeddings are generated based on the task description by a pre-processor, the embeddings are input to the generative language model, and the generative language model outputs digital content, e.g., natural language text or a combination of natural language text and non-text output, based on the embeddings.

The neural network-based machine learning model architecture of the generative model often includes one or more self-attention layers that allow the model to assign different weights to different portions of the model input (e.g., different words or phrases included in the model input). Alternatively or in addition, the neural network architecture includes feed-forward layers and residual connections that allow the model to machine-learn complex data patterns including relationships between different words or phrases in multiple different contexts. The language model or other type of generative model is capable of being constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

Supervised learning is a method of training (or fine-tuning) a machine learning model given input-output pairs, where the output of the input-output pair is known (e.g., an expected output, a labeled output, a ground truth). Other training methods including semi-supervised learning or federated learning are capable of being used to train a machine learning model or to fine-tune a pretrained machine learning model.

The transformer model 742 is configured and implemented as a network service, in some examples. The transformer model 742 is configured using a machine learning library and an application programming interface (API), e.g., via an API call such as ML_library.model(p1, p2, . . . pn), where p indicates a parameter or argument of the call, such as a model hyperparameter or an input identifier. Once configured, the transformer model 742 and/or its output are hosted on one or more servers and/or data storage devices for accessibility to one or more requesting processes, systems, devices, frameworks, or services.

The examples shown in FIG. 7C and the accompanying description, above are provided for illustration purposes. This disclosure is not limited to the described examples.

FIG. 8 is a block diagram of an example computer system including components of a retrieval and ranking system in accordance with some examples of the present disclosure.

In FIG. 8, an example machine of a computer system 800 is shown, within which a set of instructions for causing the machine to perform any of the methodologies discussed herein are capable of being executed. In some examples, the computer system 800 corresponds to a component of a networked computer system (e.g., any one or more of the components shown in FIG. 1, FIG. 2, FIG. 3, FIG. 4, FIG. 5, FIG. 6, or FIGS. 7A-7C) that includes, is coupled to, or utilizes a machine to execute an operating system to perform operations corresponding to any one or more components shown in FIG. 1, FIG. 2, FIG. 3, FIG. 4, FIG. 5, FIG. 6, or FIGS. 7A-7C. For example, computer system 800 corresponds to a portion of a computing system when the computing system is executing a portion of any one or more components shown in FIG. 1, FIG. 2, FIG. 3, FIG. 4, FIG. 5, FIG. 6, or FIGS. 7A-7C.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 802 includes a special-purpose processing device such as an application specific integrated circuit (ASIC), a field programmable gate array (FPGA), a digital signal processor (DSP), network processor, or the like. The processing device 802 is to execute instructions 812 for performing the operations and steps discussed herein.

In some examples of FIG. 8, retrieval and ranking system 850 represents portions of retrieval and ranking system 104, 201, 401, or 680 while the computer system 800 is executing those portions of retrieval and ranking system 104, 201, 401, or 680. Instructions 812 include portions of retrieval and ranking system 850 when those portions of the retrieval and ranking system 850 are being executed by processing device 802. Thus, the retrieval and ranking system 850 is shown in dashed lines as part of instructions 812 to illustrate that, at times, portions of the retrieval and ranking system 850 are executed by processing device 802. For example, when at least some portion of the retrieval and ranking system 850 is embodied in instructions to cause processing device 802 to perform the method(s) described herein, some of those instructions are read into processing device 802 (e.g., into an internal cache or other memory) from main memory 804 and/or data storage system 840. In some examples, it is not required that all of the retrieval and ranking system 850 be included in instructions 812 at the same time and portions of the retrieval and ranking system 850 are stored in another component of computer system 800 at other times, e.g., when a portion of the retrieval and ranking system 850 is not being executed by processing device 802.

The computer system 800 further includes a network interface device 808 to communicate over the network 820. Network interface device 808 provides a two-way data communication coupling to a network. In some examples, network interface device 808 includes an integrated-services digital network (ISDN) card, cable modem, satellite modem, or a modem to provide a data communication connection to a corresponding type of telephone line. In some examples, network interface device 808 includes a local area network (LAN) card to provide a data communication connection to a compatible LAN. Wireless links are included, in some examples. Network interface device 808 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 is capable of sending messages and receiving data, including program code, through the network(s) and network interface device 808. In some examples, a server is capable of transmitting a requested code for an application program through the Internet and network interface device 808. The received code is executed by processing device 802 as it is received, and/or stored in data storage system 840 or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 includes an input device, for example, alphanumeric keys and other keys configured for communicating information and command selections to processing device 802. An input device sometimes includes a cursor control, such as a mouse, a trackball, or cursor direction keys for communicating direction information and command selections to processing device 802 and for controlling cursor movement on a display. An input device sometimes includes a microphone, a sensor, or an array of sensors, for communicating sensed information to processing device 802. Examples of sensed information include voice commands, audio signals, geographic location information, haptic information, and/or digital imagery, for example.

The data storage system 840 includes a machine-readable storage medium 842 (also known as a computer-readable medium) on which is stored instructions 844 or software embodying any of the methodologies or functions described herein. The instructions 844 sometimes reside, completely or at least partially, within the main memory 804 and/or within the processing device 802 during execution thereof by the computer system 800, the main memory 804 and the processing device 802 also constituting machine-readable storage media. In one example, the instructions 844 include instructions to implement functionality corresponding to a retrieval and ranking system (e.g., any one or more of the components shown in any one or more components shown in FIG. 1, FIG. 2, FIG. 3, FIG. 4, FIG. 5, FIG. 6, or FIGS. 7A-7C).

Dashed lines are used in FIG. 8 to indicate that it is not required that the retrieval and ranking system be embodied entirely in instructions 812, 814, and 844 at the same time. In one example, portions of the retrieval and ranking system are embodied in instructions 814, which are read into main memory 804 as instructions 814, and portions of instructions 812 are read into processing device 802 as instructions 812 for execution. In another example, some portions of the retrieval and ranking system are embodied in instructions 844 while other portions are embodied in instructions 814 and still other portions are embodied in instructions 812.

While the machine-readable storage medium 842 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 8 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3, FIG. 4, FIG. 5, FIG. 6, FIG. 7A-FIG. 7C and/or FIG. 8, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in artificial intelligence (AI) features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform. According to the techniques described herein, personal data may be removed from any training dataset that is used to train AI models.

The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Illustrative examples of the technologies disclosed herein are provided below. An example of the technologies includes any of the examples described herein, or any combination of any of the examples described herein, or any combination of any portions of the examples described herein.

In some aspects, the techniques described herein relate to a method including: via a first serving path, (i) providing entity-item pairs to a first machine learning model, (ii) receiving a first subset of the entity-item pairs from the first machine learning model, (iii) providing the first subset of the entity-item pairs to a second machine learning model, and (iv) receiving first predictive output from the second machine learning model, wherein the first predictive output is generated by the second machine learning model in response to the first subset of the entity-item pairs; via a second serving path, (i) providing the entity-item pairs to the second machine learning model, (ii) receiving second predictive output from the second machine learning model, wherein the second predictive output is generated by the second machine learning model in response to the entity-item pairs, and (iii) logging the second predictive output; computing an alignment of a first objective of the first machine learning model with a second objective of the second machine learning model using the first predictive output and the logged second predictive output; and using the alignment to update the first machine learning model.

In some aspects, the techniques described herein relate to a method, wherein the subset of the entity-item pairs is generated by the first machine learning model using pseudo labels generated by the second machine learning model.

In some aspects, the techniques described herein relate to a method, wherein the first serving path generates and logs the first predictive output within a first computing environment and the second serving path generates and logs the second predictive output within a second computing environment different from the first computing environment.

In some aspects, the techniques described herein relate to a method, further including: providing unlabeled entity-item pairs to the second machine learning model, wherein the second machine learning model is trained according to a first objective; receiving pseudo labels for the unlabeled entity-item pairs from the second machine learning model; and training the first machine learning model according to a second objective using the pseudo labels received from the second machine learning model.

In some aspects, the techniques described herein relate to a method, further including: computing the alignment by determining a regret using the first predictive output and the second predictive output; and using the regret to align the first objective of the first machine learning model with the second objective of the second machine learning model.

In some aspects, the techniques described herein relate to a method, further including: implementing the first machine learning model on a graphics processing unit (GPU); and generating the first predictive output via the GPU.

In some aspects, the techniques described herein relate to a method, further including: implementing an attribute-based matching (ABM) component on the GPU; using the ABM component to generate a second subset of the entity-item pairs; and applying the first machine learning model to the second subset of the entity-item pairs to produce the first subset of the entity-item pairs.

In some aspects, the techniques described herein relate to a method, wherein the first machine learning model further includes an embedding-based retrieval (EBR) component on the GPU, and the method further includes: using the EBR component to generate the first predictive output via the GPU.

In some aspects, the techniques described herein relate to a method, further including: storing item embeddings for items of the entity-item pairs on the GPU; computing an entity embedding for the entity of the entity-item pairs; and providing the entity embedding and the item embeddings to the first machine learning model on the GPU.

In some aspects, the techniques described herein relate to a method, further including: obtaining a boost value from a pacing service; and using the boost value as an input to at least one of generation of the first predictive output or generation of the second predictive output.

In some aspects, the techniques described herein relate to a method, wherein the second machine learning model includes an auction service and the first machine learning model includes an approximation of the auction service.

In some aspects, the techniques described herein relate to a method, further including: via the first serving path, receiving feedback via a device in response to a presentation of a digital content item; modifying a pseudo label in response to the feedback; and using the modified pseudo label to update at least one of the second machine learning model or the first machine learning model.

In some aspects, the techniques described herein relate to a method, wherein the entity-item pairs include a first number of digital content items, the first subset of the entity-item pairs includes a second number of digital content items, wherein the second number is lower than the first number, and the first predictive output includes a third number of digital content items, wherein the third number is lower than the second number.

In some aspects, the techniques described herein relate to a method, further including: using the alignment to control whether a digital content item of at least one of the first predictive output or the second predictive output is provided to an entity via a device.

In some aspects, the techniques described herein relate to a system including: a processor; and a memory including instructions that when executed by the processor cause the processor to: via a first serving path, (i) provide entity-item pairs to a first machine learning model, (ii) receive a first subset of the entity-item pairs from the first machine learning model, (iii) providing the first subset of the entity-item pairs to a second machine learning model, and (iv) receive first predictive output from the second machine learning model, wherein the first predictive output is generated by the second machine learning model in response to the first subset of the entity-item pairs; via a second serving path, (i) provide the entity-item pairs to the second machine learning model, (ii) receive second predictive output from the second machine learning model, wherein the second predictive output is generated by the second machine learning model in response to the entity-item pairs, and (iii) log the second predictive output; compute an alignment of a first objective of the first machine learning model with a second objective of the second machine learning model using the first predictive output and the logged second predictive output; and use the alignment to update the first machine learning model.

In some aspects, the techniques described herein relate to a system, wherein the instructions further cause the processor to: provide unlabeled entity-item pairs to the second machine learning model, wherein the second machine learning model is trained according to a first objective; receive pseudo labels for the unlabeled entity-item pairs from the second machine learning model; and train the first machine learning model according to a second objective using the pseudo labels received from the second machine learning model.

In some aspects, the techniques described herein relate to a system, wherein the instructions further cause the processor to: implement the first machine learning model on a graphics processing unit (GPU); and generate the first predictive output via the GPU.

In some aspects, the techniques described herein relate to a system, wherein the first machine learning model further includes an embedding-based retrieval (EBR) component on the GPU, and the instructions further cause the processor to: implement an attribute-based matching (ABM) component on the GPU; use the EBR component to generate the first predictive output via the GPU; store item embeddings for items of the entity-item pairs on the GPU; use the ABM component to generate a second subset of the entity-item pairs; apply the first machine learning model to the second subset of the entity-item pairs to produce the first subset of the entity-item pairs; compute an entity embedding for the entity of the entity-item pairs; and provide the entity embedding and the item embeddings to the first machine learning model on the GPU.

In some aspects, the techniques described herein relate to a non-transitory computer-readable medium including instructions that when executed by a processor cause the processor to: via a first serving path, (i) provide entity-item pairs to a first machine learning model, (ii) receive a first subset of the entity-item pairs from the first machine learning model, (iii) provide the first subset of the entity-item pairs to a second machine learning model, and (iv) receive first predictive output from the second machine learning model, wherein the first predictive output is generated by the second machine learning model in response to the first subset of the entity-item pairs; via a second serving path, (i) provide the entity-item pairs to the second machine learning model, (ii) receive second predictive output from the second machine learning model, wherein the second predictive output is generated by the second machine learning model in response to the entity-item pairs, and (iii) log the second predictive output; computing an alignment of a first objective of the first machine learning model with a second objective of the second machine learning model using the first predictive output and the logged second predictive output; and using the alignment to update the first machine learning model.

In some aspects, the techniques described herein relate to a non-transitory computer-readable medium, wherein the instructions further cause the processor to: provide unlabeled entity-item pairs to the second machine learning model, wherein the second machine learning model is trained according to a first objective; receive pseudo labels for the unlabeled entity-item pairs from the second machine learning model; and train the first machine learning model according to a second objective using the pseudo labels received from the second machine learning model.

Aspects of the disclosure have been described with reference to specific examples thereof. Various modifications are capable of being made to the described examples without departing from the spirit and scope of the disclosure reflected in the claims. The specification and drawings are illustrative and not restrictive.

1. A method comprising:
providing entity-item pairs to a first serving path and a second serving path, wherein the first serving path and the second serving path independently process the entity-item pairs;
via a first serving path, (i) providing the entity-item pairs to a retrieval machine learning model, (ii) receiving a first subset of the entity-item pairs from the retrieval machine learning model, (iii) providing the first subset of the entity-item pairs to a ranking machine learning model, and (iv) receiving first predictive output from the ranking machine learning model, wherein the first predictive output is generated by the ranking machine learning model from the first subset of the entity-item pairs;
via a second serving path, (i) providing the entity-item pairs to the ranking machine learning model, (ii) receiving second predictive output from the ranking machine learning model, wherein the second predictive output is generated by the ranking machine learning model from the entity-item pairs, and (iii) storing the second predictive output in memory;
retrieving the second predictive output from the memory;
computing an alignment of a retrieval objective of the retrieval machine learning model with a ranking objective of the ranking machine learning model based on a comparison of the first predictive output generated from the first subset of the entity-item pairs and the retrieved second predictive output generated from the entity-item pairs; and
using the alignment to update the retrieval machine learning model.

2. The method of claim 1, wherein the subset of the entity-item pairs is generated by the retrieval machine learning model using pseudo labels generated by the ranking machine learning model.

3. The method of claim 1, wherein the first serving path generates and stores the first predictive output within a first computing environment and the second serving path generates and stores the second predictive output within a second computing environment different from the first computing environment.

4. The method of claim 1, further comprising:
providing unlabeled entity-item pairs to the ranking machine learning model, wherein the ranking machine learning model is trained according to a first objective;
receiving pseudo labels for the unlabeled entity-item pairs from the ranking machine learning model; and
training the first retrieval machine learning model according to a second objective using the pseudo labels received from the ranking machine learning model.

5. The method of claim 1, further comprising:
computing the alignment by determining a regret using the first predictive output and the second predictive output; and
using the regret to align the retrieval objective of the retrieval machine learning model with the ranking objective of the ranking machine learning model.

6. The method of claim 1, further comprising:
implementing the retrieval machine learning model on a graphics processing unit (GPU); and
generating the first predictive output via the GPU.

7. The method of claim 6, further comprising:
implementing an attribute-based matching (ABM) component on the GPU;
using the ABM component to generate a second subset of the entity-item pairs; and
applying the retrieval machine learning model to the second subset of the entity-item pairs to produce the first subset of the entity-item pairs.

8. The method of claim 6, wherein the retrieval machine learning model further comprises an embedding-based retrieval (EBR) component on the GPU, and the method further comprises:
using the EBR component to generate the the first subset of the entity-item pairs via the GPU.

9. The method of claim 6, further comprising:
storing item embeddings for items of the entity-item pairs on the GPU;
computing an entity embedding for the entity of the entity-item pairs; and
providing the entity embedding and the item embeddings to the retrieval machine learning model on the GPU.

10. The method of claim 1, further comprising:
obtaining a boost value from a pacing service; and
using the boost value as an input to at least one of generation of the first predictive output or generation of the second predictive output.

11. The method of claim 1, wherein the ranking machine learning model comprises an auction service and the retrieval machine learning model comprises an approximation of the auction service.

12. The method of claim 1, further comprising:
via the first serving path, receiving feedback via a device in response to a presentation of a digital content item;
modifying a pseudo label in response to the feedback; and
using the modified pseudo label to update at least one of the ranking machine learning model or the retrieval machine learning model.

13. The method of claim 1, wherein the entity-item pairs comprise a first number of digital content items, the first subset of the entity-item pairs comprises a second number of digital content items, wherein the second number is lower than the first number, and the first predictive output comprises a third number of digital content items, wherein the third number is lower than the second number.

14. The method of claim 1, further comprising:
using the updated retrieval machine learning model to control whether a digital content item of at least one of the first predictive output or the second predictive output is provided to an entity via a device.

15. A system comprising:
a processor; and
a memory comprising instructions that when executed by the processor cause the processor to:
provide entity-item pairs to a first serving path and a second serving path, wherein the first serving path and the second serving path independently process the entity-item pairs;
via a first serving path, (i) provide the entity-item pairs to a retrieval machine learning model, (ii) receive a first subset of the entity-item pairs from the retrieval machine learning model, (iii) provide the first subset of the entity-item pairs to a ranking machine learning model, and (iv) receive first predictive output from the ranking machine learning model, wherein the first predictive output is generated by the ranking machine learning model from the first subset of the entity-item pairs;
via a second serving path, (i) provide the entity-item pairs to the ranking machine learning model, (ii) receive second predictive output from the ranking machine learning model, wherein the second predictive output is generated by the ranking machine learning model from the entity-item pairs, and (iii) store the second predictive output in memory;
retrieve the second predictive output from the memory;
compute an alignment of a retrieval objective of the retrieval machine learning model with a ranking objective of the ranking machine learning model based on a comparison of the first predictive output generated from the first subset of the entity-item pairs and the retrieved second predictive output generated from the entity-item pairs; and
use the alignment to update the retrieval machine learning model.

16. The system of claim 15, wherein the instructions further cause the processor to:
provide unlabeled entity-item pairs to the ranking machine learning model, wherein the ranking machine learning model is trained according to a first objective;
receive pseudo labels for the unlabeled entity-item pairs from the ranking machine learning model; and
train the retrieval machine learning model according to a second objective using the pseudo labels received from the ranking machine learning model.

17. The system of claim 15, wherein the instructions further cause the processor to:
implement the retrieval machine learning model on a graphics processing unit (GPU); and
generate the first predictive output via the GPU.

18. The system of claim 17, wherein the first retrieval machine learning model comprises an embedding-based retrieval (EBR) component on the GPU, and the instructions further cause the processor to:
implement an attribute-based matching (ABM) component on the GPU;
store item embeddings for items of the entity-item pairs on the GPU;
use the ABM component to generate a second subset of the entity-item pairs;
apply the retrieval machine learning model to the second subset of the entity-item pairs to produce the first subset of the entity-item pairs;
compute an entity embedding for the entity of the entity-item pairs; and
provide the entity embedding and the item embeddings to the retrieval machine learning model on the GPU.

19. A non-transitory computer-readable medium comprising instructions that when executed by a processor cause the processor to:
provide entity-item pairs to a first serving path and a second serving path, wherein the first serving path and the second serving path independently process the entity-item pairs;
via a first serving path, (i) provide the entity-item pairs to a retrieval machine learning model, (ii) receive a first subset of the entity-item pairs from the retrieval machine learning model, (iii) provide the first subset of the entity-item pairs to a ranking machine learning model, and (iv) receive first predictive output from the ranking machine learning model, wherein the first predictive output is generated by the ranking machine learning model from the first subset of the entity-item pairs;
via a second serving path, (i) provide the entity-item pairs to the ranking machine learning model, (ii) receive second predictive output from the ranking machine learning model, wherein the second predictive output is generated by the ranking machine learning model from the entity-item pairs, and (iii) store the second predictive output in memory;
retrieve the second predictive output from the memory;
compute an alignment of a retrieval objective of the retrieval machine learning model with a ranking objective of the ranking machine learning model based on a comparison of the first predictive output generated from the first subset of the entity-item pairs and the retrieved second predictive output generated from the entity-item pairs; and
use the alignment to update the retrieval machine learning model.

20. The non-transitory computer-readable medium of claim 19, wherein the instructions further cause the processor to:
provide unlabeled entity-item pairs to the ranking machine learning model, wherein the ranking machine learning model is trained according to a first objective;
receive pseudo labels for the unlabeled entity-item pairs from the ranking machine learning model; and
train the retrieval machine learning model according to a second objective using the pseudo labels received from the ranking machine learning model.
